(19) United States
(12) Patent Application Publication
(10) Pub. No.: US 2026/0230394 A1
(43) Pub. Date: Aug. 6, 2026

(54) MACHINE LEARNING SOLUTIONS FOR RLC SDU CONSTRUCTION IN NON-IP DATA DELIVERY TRANSMISSION OVER NON-TERRESTRIAL NETWORKS

(71) Applicant: QUALCOMM Incorporated, San Diego, CA (US)

(72) Inventors: Soumya Das, San Diego, CA (US); Sundervelu Palanivelu Tandalam, San Diego, CA (US); Mohsen Bahrami, Carlsbad, CA (US)

(21) Appl. No.: 19/044,412

(22) Filed: Feb. 3, 2025

(51) Int. Cl. H04L 41/16; H04L 1/20; H04W 24/02

(52) U.S. Cl. CPC H04L 41/16; H04L 1/203; H04W 24/02

(57) ABSTRACT

A device for communication in a non-terrestrial communication system includes: one or more memories configured to store: historical values of model parameters of a machine learning (ML) model, and one or more processors are configured to: send, by an application layer, metadata associated with one data transmission unit of a plurality of data transmission units indicating that the corresponding data transmission unit comprises a last data transmission unit associated with a particular application payload; receive, by the RLC layer, the metadata associated with the one data transmission unit; apply, by the RLC layer, the ML model, using the historical values of the model parameters to determine likelihood of data loss; and set, by the RLC layer, a poll bit in the data transmission unit when the likelihood of data loss exceeds a threshold.

### TECHNICAL FIELD

The technology discussed below relates generally to wireless communication systems.

### BACKGROUND

In a wireless communication system, NB-IoT (NarrowBand Internet of Things) NTN (Non-Terrestrial Network) refers to the extension of NB-IoT technology to satellite communications. Control Plane Cellular Internet of Things (CIoT) Evolved Packet System (EPS) optimization is a set of techniques to optimize the control plane for IoT devices in the EPS. A Non-IP Data Delivery Packet Data Unit (NIDD PDU) is a data unit that may be used to transport non-IP data over a NB-IoT network. If an application payload exceeds a configured Maximum Transmission Unit (MTU) size for a non-IP data container, an application may segment the payload into smaller NIDD segments. This segmentation may be needed to better ensure that the payload is able to be successfully transmitted within the available network capacity. However, due to the dynamic nature of Radio Link Control (RLC) segmentation, segments belonging to the same application payload may be placed into different RLC Service Data Units (SDUs).

### SUMMARY

The following presents a summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

In one example, a system is described for application-controlled RLC SDU construction. For instance, the application may provide metadata to an RLC layer to guide the formation of RLC SDUs. The objective of the disclosed techniques is to better ensure that each RLC SDU contains NIDD segments belonging to only a single application. The disclosed system may employ a PSH flag that may signal the RLC layer to treat the current dedicatedInfoNAS (Non-Access Stratum) RRC (Radio Resource Control) message as the last message to be included in the current RLC SDU. The PSH flag may better ensure, for example, that the data for the current application is transmitted promptly without waiting for the RLC buffer to fill up. In addition, the URG (Urgent) flag may signal the RLC layer to treat the current dedicatedInfoNAS RRC message as urgent. In this example, irrespective of the RLC Tx buffer state, the RLC layer should set the poll bit in the last RLC AMD (acknowledged mode) PDU of the current RLC SDU before submitting the RLC SDU to the lower layer.

The URG flag may trigger an immediate acknowledgment from the receiver, providing quicker feedback on the successful transmission of the urgent data. In this disclosure, a wireless device is a device configured to perform wireless communication. Example wireless devices may include base stations, user equipment, access points, wireless nodes, and so on.

In some examples, this disclosure describes a device for communication in a non-terrestrial communication system that includes: one or more memories configured to store: historical values of model parameters of a machine learning (ML) model, and one or more processors are configured to: send, by an application layer, metadata associated with one data transmission unit of a plurality of data transmission units indicating that the corresponding data transmission unit comprises a last data transmission unit associated with a particular application payload; receive, by the RLC layer, the metadata associated with the one data transmission unit; apply, by the RLC layer, the ML model, using the historical values of the model parameters to determine likelihood of data loss; and set, by the RLC layer, a poll bit in the data transmission unit when the likelihood of data loss exceeds a threshold.

In some examples, this disclosure describes a method for communication in a non-terrestrial communication system including: sending, by an application layer, metadata associated with one data transmission unit of a plurality of data transmission units, the metadata indicating that the one data transmission unit comprises a last data transmission unit associated with a particular application payload; receiving, by a Radio Link Control (RLC) layer, the metadata associated with the one data transmission unit; applying a Machine Learning (ML) model, using historical values of model parameters of the ML model, to determine a likelihood of data loss; and setting, by the RLC layer, a poll bit in the last data transmission unit when the likelihood of data loss exceeds a threshold.

In some examples, this disclosure describes non-transitory computer-readable storage media having instructions encoded thereon, the instructions configured to cause processing circuitry to: send, by an application layer, metadata associated with one data transmission unit of a plurality of data transmission units, the metadata indicating that the one data transmission unit comprises a last data transmission unit associated with a particular application payload; receive, by a Radio Link Control (RLC) layer, the metadata associated with the one data transmission unit; apply a Machine Learning (ML) model, using historical values of model parameters of the ML model, to determine a likelihood of data loss; and set, by the RLC layer, a poll bit in the last data transmission unit when the likelihood of data loss exceeds a threshold.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a wireless communication system that supports timing adjustment in non-terrestrial wireless communications according to some aspects of this disclosure.

FIG. 2 is a schematic illustration of a wireless communication system that supports timing adjustment in non-terrestrial wireless communications according to some aspects of this disclosure.

FIG. 3A is a schematic illustration of a user plane protocol stack and a control plane protocol stack in accordance with some aspects of this disclosure.

FIG. 3B is a schematic illustration of a user plane protocol stack and a control plane protocol stack for a sidelink interface between a pair of UEs in accordance with some aspects of this disclosure.

FIG. 4 is a block diagram illustrating an example of a hardware implementation for a network node employing a processing system in accordance with some aspects of this disclosure.

FIG. 5 is a conceptual diagram illustrating an example signal generation process in a non-terrestrial communication system that enhances an interface between the application layer and the RLC layer, in accordance with one or more techniques of this disclosure.

FIG. 6 is a conceptual diagram illustrating an example signal generation process in a non-terrestrial communication system that employs a machine learning model for RLC SDU construction based on a push flag, in accordance with one or more techniques of this disclosure.

FIG. 7 is a conceptual diagram illustrating an example system that employs a machine learning model for RLC SDU size determination in NTN environments where Global Navigation Satellite Systems (GNSS) signal degradation may impact communication, in accordance with one or more techniques of this disclosure.

FIG. 8 is a conceptual diagram illustrating an example system that performs RLC SDU construction, in accordance with one or more techniques of this disclosure.

FIG. 9 is a flowchart illustrating an example operation of a transmitting device, in accordance with one or more techniques of this disclosure.

FIG. 10 is an illustrative block diagram of an example ML model represented by a Multi-Layer Perceptron (MLP).

### DETAILED DESCRIPTION

Non-terrestrial networks (sometimes referred to as NTNs) may provide coverage by using high-altitude vehicles between user terminals and gateways or base stations (e.g., next-generation NodeBs or giga-NodeBs (which may be referred to as a gNB, and also referred to as access stations or access gateways)). A gateway may, for example, transmit data to a satellite which may then be relayed to a user terminal or vice-versa. A high-altitude vehicle may be a base station in some examples. A user terminal may be any device capable of transmitting signals to a satellite. Examples of a user terminal may include a user equipment (UE), a relay equipment configured to relay a signal between a satellite and a user terminal, or a combination thereof. NTNs may involve the use of high altitude platform stations (HAPSs) and/or satellites to provide coverage for terrestrial base stations and UEs. The terms HAPS and satellite are used interchangeably herein to refer to a remote NTN device that may provide coverage to one or more other high altitude or terrestrial devices. Likewise, the terms gateway and base station are used interchangeably herein to refer to a network node that serves a UE and provides network access to the UE.

The gateway and the satellite may be thousands of kilometers apart and it may take some time for electromagnetic waves to propagate over the distance between the gateway and the satellite and between the satellite and the user terminal. Thus, the propagation delay for non-terrestrial networks may be many orders of magnitude larger than the propagation delay for terrestrial networks. As such, the round trip delay (sometimes referred to as an RTD) associated with a signal may also be orders of magnitude larger for non-terrestrial networks than for terrestrial networks. Further, due to the high mobility of high-altitude vehicles such as non-geostationary satellites, communications with the non-geostationary satellites may promote large and time-varying round trip delays. Variations in round trip delay may cause user terminals to experience variation in uplink timing and frequency synchronization with satellites. As demand for communication efficiency increases, it may be desirable for wireless communications systems to support techniques for estimating and determining uplink timing that account for round trip delay as well as variation in round trip delay.

As described herein, ues, base stations or gateways, and satellites may support estimating propagation delay and propagation delay variation for use in determining timing for uplink transmissions from a UE to a gateway via a satellite. In some cases, a UE may determine uplink timing such that an uplink transmission from the UE to the gateway arrives at the gateway in a time-synchronized manner. The UE may apply a timing advance to determine the uplink timing based on the estimated propagation delay and propagation delay variation between the UE and the satellite, between the satellite and the gateway, or any combinations thereof. In some cases, propagation delay and propagation delay variation may be determined based on a gateway timing reference (e.g., a base station timing reference), or based on a satellite timing reference. In some cases, a serving gateway may configure the UE to use one of the gateway or satellite timing references. In some cases, the serving gateway may provide information related to round trip delay, variation in round trip delay, or both, to assist the UE in determining uplink timing.

Machine learning (ML) models are becoming increasingly ubiquitous in modern electronic devices. For example, wireless devices may use ML models for spectrum management, power management, position determination, and so on. In some instances, devices may use ML models for RLC SDU construction in Non-IP Data Delivery (NIDD) transmission (TX) over Narrowband Non-Terrestrial Network (NB-NTN).

NB-IoT NTN refers to the extension of NB-IoT technology to satellite communications. Control Plane CIoT EPS optimization is a set of techniques to optimize the control plane for IoT devices in the EPS. A NIDD PDU may be a data unit used to transport non-IP data over the NB-IoT network. A NAS EPS Session Management (ESM) data transport message may be a message used in the NAS layer to transport user data, including NIDD PDUs. If the application payload exceeds the configured MTU size for the non-IP data container, the application may segment the payload into smaller NIDD segments. This segmentation may be needed to better ensure that the payload may be successfully transmitted within the available network capacity. For instance, each NIDD segment may be encapsulated within a NIDD PDU. The NIDD PDU may then be placed inside the NAS ESM data transport message. The NAS ESM data transport message containing the NIDD PDUs may be transmitted over the NB-IoT NTN network. The application payload may be segmented if the application payload exceeds the MTU size.

NAS ESM data transport messages may be conveyed within dedicatedinfoNAS RRC messages. In other words, the NAS layer messages responsible for managing subscriber data may be encapsulated within the Radio Resource Control (RRC) layer messages, which handle the overall radio communication. RLC (Radio Link Control) is responsible for segmenting and packetizing the RRC messages. RLC may divide these messages into smaller units called RLC SDUs based on factors, such as, but not limited to, available bandwidth (UL grants), the size of the data blocks (TBS), and the rate at which acknowledgments/negative acknowledgments (ACK/NACK) are received.

RLC SDUs may contain segments of different application payloads. That is, this flexibility may allow for efficient utilization of available resources. However, this segmentation may also mean that segments belonging to the same application data may be distributed across multiple RLC SDUs. NAS ESM data transport messages may carry important information for managing subscriber data, such as authentication, authorization, and service provisioning. NAS ESM data transport messages may be essential for establishing and maintaining a connection between the UE and the network. The dedicatedinfoNAS RRC message may specifically carry the NAS ESM data transport messages. Thus, the dedicatedinfoNAS RRC message may act as a container for these NAS messages, ensuring their proper transmission over the radio interface.

RLC may divide the dedicatedinfoNAS RRC messages into smaller RLC SDUs. This segmentation is dynamic and depends on various factors, such as, but not limited to: UL grants, TBS, ACK/NACK rate. The UL grants may represent the amount of radio resources allocated for uplink transmission. The TBS may represent the size of the data blocks that may be transmitted efficiently within a given time slot. The ACK/NACK rate may be the rate at which acknowledgments or negative acknowledgments are received from the network, indicating the success or failure of data transmission.

In NB-NTN and New Radio Non-Terrestrial Networks (NR-NTN), even with robust error correction mechanisms, there may be gaps or “holes” in the received RLC SDUs. Poor signal strength (RSRP) or a low signal-to-noise ratio (SNR) may increase the probability of transmission errors, leading to dropped or corrupted RLC SDUs. High Hybrid ARQ Round Trip Times (HARQ-RTT) indicate delays in retransmissions, potentially exceeding buffer limits or causing the UE to miss retransmission opportunities. Frequent HARQ failures suggest persistent interference or severe channel impairments, resulting in the loss of critical data. Large TBS values may increase the probability of errors in a single transmission, especially in poor channel conditions. Higher MCS (Modulation and Coding Scheme) values offer higher throughput but are more susceptible to errors in noisy channels. Insufficient resource allocation may lead to data loss if the channel cannot accommodate the required transmission rate. A limited number of Physical Uplink Shared Channel (PUSCH) repetitions may not be sufficient to ensure reliable delivery in challenging channel conditions. RLC SDU gaps may have a significant impact on the performance of upper-layer protocols, such as Transmission Control Protocol (TCP) and User Datagram Protocol (UDP). Upper-layer protocols may need to retransmit data due to missing RLC SDUs, leading to decreased throughput and increased latency. Some protocols, like TCP, rely on the ordered delivery of data. RLC SDU gaps may disrupt this order, leading to protocol violations and potential application errors. Depending on the application, missing data may lead to various issues, such as video stuttering, audio glitches, or incorrect data interpretation.

In NB-IoT networks, especially those employing NIDD, scenarios where segments of a single application payload are distributed across multiple RLC SDUs can pose significant challenges, particularly in the context of NTNs with their inherent high Round Trip Times (RTTs). NIDD allows for efficient transmission of application data by segmenting the application data into smaller units. However, the segmentation process may not always align perfectly with RLC SDU boundaries. This can result in a situation where different segments belonging to the same application payload are placed into separate RLC SDUs. If RLC SDUs containing different segments of the same application payload experience varying delays or losses due to channel conditions, such delays may lead to significant jitter in the delivery of those segments at the receiver. In other words, the segments may arrive out of order or with large time gaps between them. High RTTs in NTN environments may exacerbate the aforementioned issue. Even if all RLC SDUs are successfully transmitted, the delay associated with each individual SDU may accumulate, leading to a substantial increase in the overall latency for the entire application payload. Jitter and increased latency may severely impact the performance of applications that are sensitive to timing, such as, but not limited to, real-time control systems or applications that rely on timely data delivery. Some protocols may rely on the ordered delivery of data. Out-of-order delivery of NIDD segments may lead to protocol violations and potential application errors.

This disclosure describes techniques that may address these issues. As described herein, the disclosed techniques may improve the delivery of NIDD segments and application payloads by ensuring that segments belonging to a single application are contained within a single RLC SDU. This may help prevent out-of-order delivery and may reduce jitter, especially important in delay-sensitive applications. The PSH flag may instruct the RLC layer to prioritize the immediate transmission of the current RLC SDU. The PSH flag may better ensure that the data associated with this flag is delivered promptly. When the URG flag is set, the RLC layer may be instructed to treat the current dedicatedInfoNAS RRC message as the last message to be included in the current RLC SDU. The URG flag may help maintain the integrity of critical messages. Irrespective of the RLC Tx buffer status, the URG flag may also trigger the setting of the poll bit in the last RLC AMD PDU. This setting may encourage an immediate acknowledgement from the network, providing faster feedback on the delivery status.

This disclosure also describes techniques that intelligently decide when to set the poll bit in the last RLC AMD PDU based on real-time channel conditions. A host apparatus may comprise a communication system. The host apparatus may store values of model parameters of a machine learning (ML) model (e.g., Multi-Layer Perceptron-MLP) that may be trained to predict the RLC Block Error Rate (BLER) on the uplink (UL). The ML model may utilize historical data such as, but not limited to: HARQ BLER DL/UL, HARQ retransmission/failure rates, RLC retransmission rates. If the predicted RLC BLER UL exceeds a pre-defined threshold, the RLC layer may set the poll bit in the last RLC AMD PDU when the App signals the PSH flag. This proactive technique may better ensure that critical data is acknowledged quickly, even in challenging channel conditions.

In NTN scenarios, the absence of Global Navigation Satellite Systems (GNSS) may significantly complicate timing and frequency synchronization, as the UE relies on GNSS for accurate timing advance (TA) and frequency shift compensation. The UE may need mechanisms for autonomous adjustment of TA and frequency shifts in the absence of GNSS. The disclosed techniques may utilize location information from NTN System Information. The disclosed techniques may employ ML algorithms to analyze received signals and estimate the required adjustments. In an aspect, a timer may be implemented to determine how long the UE may maintain uplink communication with the pre-compensated TA and frequency shift. If the timer expires, the UE may disconnect, acquire a GNSS fix, and reconnect to ensure reliable communication.

The disclosure that follows presents various concepts that may be implemented across a broad variety of telecommunication systems, network architectures, and communication standards.

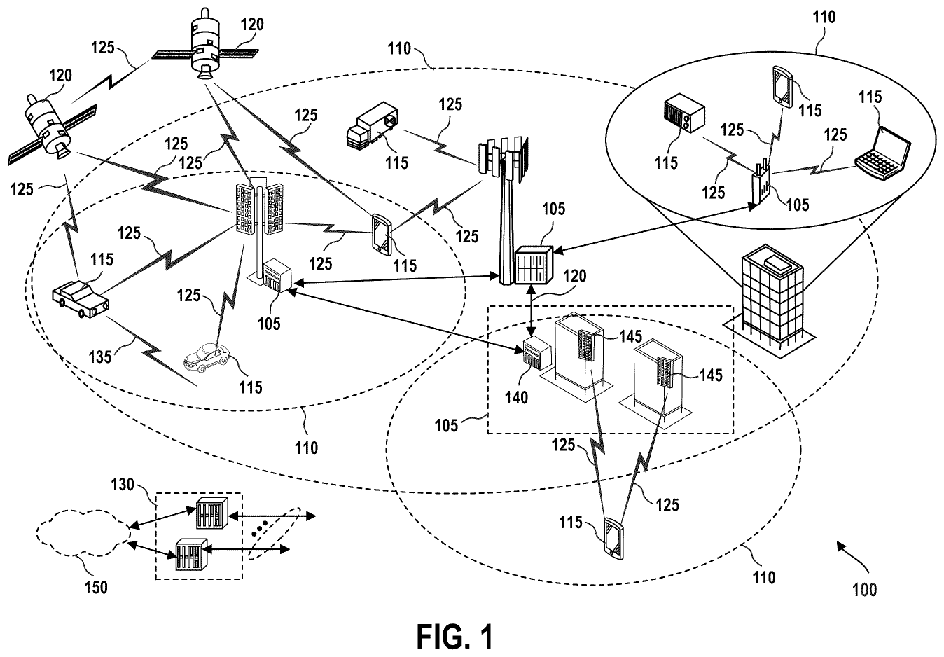

FIG. 1 illustrates an example of a wireless communications system 100 that supports timing adjustment in non-terrestrial wireless communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

A plurality of scheduling entities, such as the base stations 105, may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. Various types of backhaul interfaces may be employed, such as a direct physical connection, a virtual network, or the like using any suitable transport network. For example, the base stations 105 may interface with the core network 130 through one or more backhaul links (e.g., via an S1, N2, N3, or another interface). The base stations 105 may communicate with one another over the backhaul links (e.g., via an X2, Xn, or other interface) either directly (e.g., directly between base stations 105), or indirectly (e.g., via core network 130), or both. In some examples, the backhaul links may be or include one or more wireless links.

Broadly, a base station is a network element in a radio access network responsible for radio transmission and reception in one or more cells to or from a UE. In different technologies, standards, or contexts, those skilled in the art may variously refer to a “base station” as a base transceiver station (BTS), a radio base station, a radio transceiver, a transceiver function, a basic service set (BSS), an extended service set (ESS), an access point (AP), a Node B (NB), an evolved Node B (eNB), a gNode B (gNB), a 5G NB, a transmit receive point (TRP), or some other suitable terminology.

Those skilled in the art may refer to a mobile apparatus as a UE, as in 3GPP specifications, but may also refer to UE 115 as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. UE 115 may take on many forms and can include a range of devices UE is a common form of scheduled entity. The scheduled entity may be any type of device on a schedule of devices configured for transmitting and receiving data in wireless communication system 100. Accordingly, for ease of explanation, this disclosure refers to the scheduled entity as UE 115. FIG. 1 shows the scheduled entity as UE 115. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

Within the present document, a “mobile” apparatus (also known as UE 115) need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), a vehicle, and a broad array of embedded systems, e.g., corresponding to an “Internet of things” (IoT). A mobile apparatus, such as a UE, may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc. ; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115. However, within the scope of the present disclosure, multiplexing and multiple access are not limited to the above schemes. For example, a UE may provide for UL multiple access utilizing time division multiple access (TDMA), code division multiple access (CDMA), frequency division multiple access (FDMA), sparse code multiple access (SCMA), resource spread multiple access (RSMA), or other suitable multiple access schemes. Further, a network node may multiplex DL transmissions to UEs utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The time intervals for the base stations 105 or the UEs 115 may be expressed in multiples of a basic time unit which may, for example, refer to a sampling period of Ts=1/(Δfmax·Nf) seconds, where Δfmax may represent the maximum supported subcarrier spacing, and Nf may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1: M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 includes base stations 105, UEs 115, satellites 120, and a core network 130. In some examples, the wireless communications system 100 may be an LTE network, an LTE-A network, an LTE-A Pro network, or a NR network. In some cases, wireless communications system 100 may support enhanced broadband communications, ultra-reliable (e.g., mission critical) communications, low latency communications, or communications with low-cost and low-complexity devices.

Wireless communications system 100 may also include one or more satellites 120. Satellite 120 may communicate with base stations 105 (also referred to as gateways in NTNs) and UEs 115 (or other high altitude or terrestrial communications devices). Satellite 120 may be any suitable type of communication satellite configured to relay communications between different end nodes in a wireless communication system. Satellite 120 may be an example of a space satellite, a balloon, a dirigible, an airplane, a drone, an unmanned aerial vehicle, and/or the like. In some examples, the satellite 120 may be in a geosynchronous or geostationary earth orbit, a low earth orbit or a medium earth orbit. A satellite 120 may be a multi-beam satellite configured to provide service for multiple service beam coverage areas in a predefined geographical service area. The satellite 120 may be any distance away from the surface of the earth.

In some cases, a cell may be provided or established by a satellite 120 as part of a non-terrestrial network. A satellite 120 may, in some cases, perform the functions of a base station 105, act as a bent-pipe satellite, or may act as a regenerative satellite, or a combination thereof. In other cases, satellite 120 may be an example of a smart satellite, or a satellite with intelligence. For example, a smart satellite may be configured to perform more functions than a regenerative satellite (e.g., may be configured to perform particular algorithms beyond those used in regenerative satellites, may be configured to be reprogrammed, etc.). A bent-pipe transponder or satellite may be configured to receive signals from ground stations and transmit those signals to different ground stations. In some cases, a bent-pipe transponder or satellite may amplify signals or shift from uplink frequencies to downlink frequencies. A regenerative transponder or satellite may be configured to relay signals like the bent-pipe transponder or satellite, but may also use on-board processing to perform other functions. Examples of these other functions may include demodulating a received signal, decoding a received signal, re-encoding a signal to be transmitted, or modulating the signal to be transmitted, or a combination thereof. For example, a bent-pipe satellite (e.g., satellite 120) may receive a signal from a base station 105 and may relay the signal to a UE 115 or base station 105, or vice-versa.

UEs 115 may communicate with satellites 120 and/or base stations or gateways 105 using communications links 125. In some cases, timing adjustments to account for propagation delay communications links 125 via a satellite 120 may include a propagation delay between a UE 115 and a satellite 120, or a propagation delay between a base station 105 and a satellite 120, or both, as well as a variation in the propagation delays due to movement of the satellite. In accordance with various techniques discussed herein, a UE 115 may account for variation in propagation delay, in addition to determined propagation delay, when determining an uplink timing for uplink communications via a satellite 120.

Wireless communications between satellites 120 and UE 115 may be described as utilizing an air interface. Transmissions over the air interface from base station 105 (e.g., one of the scheduling entities) to one or more UEs 115 (e.g., a scheduled entity) may be referred to as downlink (DL) transmission. In accordance with certain aspects of the present disclosure, the term downlink may refer to a point-to-multipoint transmission originating at one of scheduling entities (e.g., base station 105). Another way to describe this scheme may be to use the term broadcast channel multiplexing. Transmissions from a UE 115 to base station 105 may be referred to as uplink (UL) transmissions. In accordance with further aspects of the present disclosure, the term uplink may refer to a point-to-point transmission originating at a scheduled entity (e.g., UE 115).

In some examples, access to the air interface may be scheduled, wherein one or more of scheduling entities (e.g., a network node) allocates resources for communication among some or all devices and equipment within its service area or cell. Within the present disclosure, as discussed further below, a scheduling entity may be responsible for scheduling, assigning, reconfiguring, and releasing resources for one or more scheduled entities. That is, for scheduled communication, UEs 115, which may be scheduled entities, may utilize resources allocated by the scheduling entity.

Base stations are not the only entities that may function as scheduling entities. That is, in some examples, a UE or network node may function as a scheduling entity, scheduling resources for one or more scheduled entities (e.g., one or more UEs 115).

As illustrated in FIG. 1, a network node (e.g., one or more of scheduling entities) may broadcast downlink traffic to one or more UEs 115. Broadly, the network node is a node or device responsible for scheduling traffic in a wireless communication network, including the downlink traffic and, in some examples, uplink traffic from one or more scheduled entities (e.g., one or more UEs 115) to the network node. On the other hand, a scheduled entity (e.g., UE 115) is a node or device that receives downlink control information, including but not limited to scheduling information (e.g., a grant), synchronization or timing information, or other control information from another entity in the wireless communication network such as the network node.

Core network 130 may be a part of wireless communication system 100 and may be independent of the radio access technology. In some examples, core network 130 may be configured according to 5G standards (e.g., 5GC). In other examples, the core network 130 may be configured according to a 4G evolved packet core (EPC), or any other suitable standard or configuration.

### In a Further Aspect of Wireless

communication system 100, sidelink signals may be used between UEs without necessarily relying on scheduling or control information from a network node (e.g., a scheduling entity). For example, two or more UEs 115 may communicate with each other using peer to peer (P2P) or sidelink signals without relaying that communication through a network node. In still another example, a UE may function as a scheduling entity in a device-to-device (D2D), peer-to-peer (P2P), or vehicle-to-vehicle (V2V) network, and/or in a mesh network. Thus, in wireless communication system 100 with scheduled access to time-frequency resources and having a cellular configuration, a P2P configuration, or a mesh configuration, a scheduling entity and one or more scheduled entities may communicate utilizing the scheduled resources.

In 5G NR specifications (Release 15), data is coded in differing manners. User data (e.g., data, data traffic, traffic, etc.) may be coded using quasi-cyclic low-density parity check (LDPC) with two different base graphs. One base graph is used for large code blocks and/or high code rates, while another base graph is used otherwise. Control information and the physical broadcast channel (PBCH) may be coded using Polar coding (e.g., based on nested sequences). For the control information and the PBCH, puncturing, shortening, and repetition are used for rate matching.

In the example of FIG. 1, scheduled entities 115, scheduling entities 105, and/or other devices in wireless communication system 100 may communicate over NB-IoT NTN (Non-Terrestrial Network), which refers to the extension of NB-IoT technology to satellite communications. For example, control plane CIoT EPS optimization may be a set of techniques to optimize the control plane for scheduled entities in the EPS. One or more of scheduling entities 105 may use NIDD PDUs as data units used to transport non-IP data over the NB-IoT network. NAS ESM data transport message may be a message used in the NAS (Non-Access Stratum) layer to transport user data, including NIDD PDUs. If the application payload exceeds the configured MTU size for the non-IP data container, the application at scheduled entities may segment the payload into smaller NIDD segments. The NAS layer messages responsible for managing subscriber data may be encapsulated within the RRC layer messages, which handle the overall radio communication. RLC is responsible for segmenting and packetizing the RRC messages. RLC at the scheduling entities may take the NAS layer messages handling functions related to user identity, security, and mobility management and divide them into smaller RLC SDUs. This segmentation may be dynamic and may depend on various factors, such as, but not limited to: UL grants, TBS, ACK/NACK rate. In 5G, even with robust error correction mechanisms, there may be gaps or “holes” in the received RLC SDUs. Poor signal strength (RSRP) or a low signal-to-noise ratio (SNR) may increase the probability of transmission errors, leading to dropped or corrupted RLC SDUs.

In some examples, a scheduling entity (e.g., one of scheduling entities 108) may improve the delivery of NIDD segments and application payloads by ensuring that segments belonging to a single application are contained within a single RLC SDU. When the App at a scheduled entity signals the PSH flag to RLC, the PSH flag may instruct RLC of the scheduled entity to prioritize the immediate transmission of the current RLC SDU. In some examples, a scheduled entity may employ a ML model to decide when to set the poll bit in the last RLC AMD PDU based on real-time channel conditions. This proactive technique may better ensure that critical data is acknowledged quickly, even in challenging channel conditions. In NTN scenarios, the absence of GNSS may significantly complicate timing and frequency synchronization, as the scheduling entities may rely on GNSS for accurate TA and frequency shift compensation. The scheduling entities may employ ML algorithms to analyze received signals and estimate the required adjustments. In an aspect, a timer may be implemented to determine how long the scheduling entity may maintain uplink communication with the pre-compensated TA and frequency shift. If the timer expires, the scheduling entity may disconnect, acquire a GNSS fix, and reconnect to ensure reliable communication.

As previously discussed, NIDD allows for efficient transmission of application data by segmenting the application data into smaller units. However, the segmentation process may not always align perfectly with RLC SDU boundaries. This can result in a situation where different segments belonging to the same application payload are placed by scheduled entities into separate RLC SDUs. If RLC SDUs containing different segments of the same application payload experience varying delays or losses due to channel conditions, such delays may lead to significant jitter in the delivery of those segments at the scheduled entity.

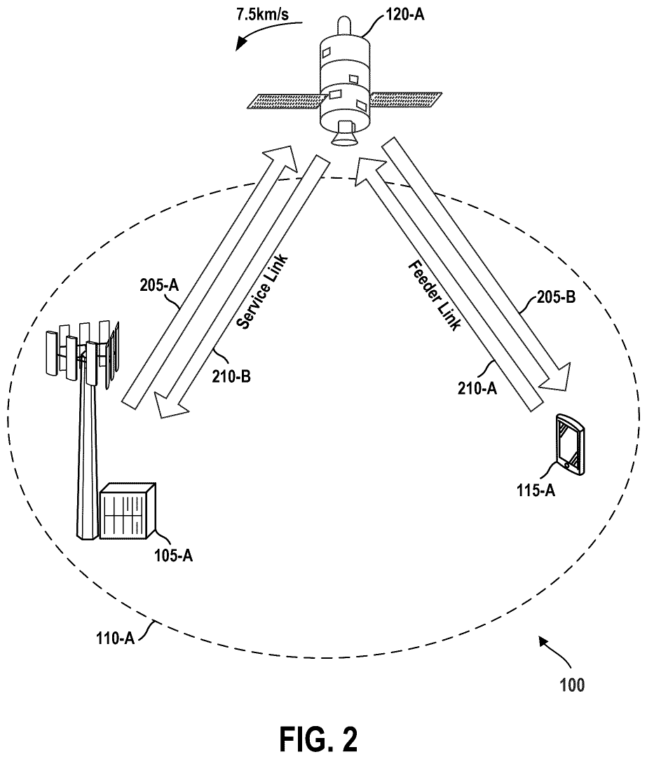

FIG. 2 illustrates an example of a wireless communications system 200 that supports timing adjustment in non-terrestrial wireless communications in accordance with aspects of the present disclosure. In some examples, wireless communications system 200 may implement aspects of wireless communications system 100. Wireless communications system 200 may include a gateway 105-a, a UE 115-a, and a satellite 120-a, which may be examples of a base station 105, UEs 115, and satellites 120 as described with reference to FIG. 1. The gateway 105-a may serve a coverage area 110-a in examples of a terrestrial network, and the satellite 120-a may serve coverage area 110-a in examples of an NTN.

In some examples, the satellite 120-a may relay communications between the gateway 105-a and the UE 115-a. For example, the gateway 105-a may communicate with the UE 115-a via the satellite 120-a or vice-versa. In some examples, for communications originating at the gateway 105-a and going to the UE 115-a, the gateway 105-a may transmit an uplink transmission 205-a to the satellite 120-a, which may be referred to as a service link. The satellite 120-a may relay the uplink transmission 205-a as a downlink transmission 205-b to the UE 115-a, which may be referred to as a feeder link. In other examples, for communications originating at the UE 115-a and going to the gateway 105-a, the UE 115-a may transmit an uplink transmission 210-a to the satellite 120-a via feeder link. The satellite 120-a may relay the uplink transmission 210-a as a downlink transmission 210-b to gateway 105-b via the service link.

### The Gateway 105-a and the Satellite 120-a

may be thousands of kilometers apart and it may take some time for electromagnetic waves to propagate over the distance between the gateway 105-a and the satellite 120-a and between the satellite 120-a and the UE 115-a. The propagation delay for non-terrestrial networks may be many orders of magnitude larger than the propagation delay for terrestrial networks. As such, the round-trip delay associated with a transmission may also be orders of magnitude larger for non-terrestrial networks than for terrestrial networks. In addition, high speeds of non-geostationary satellites, for example, such as the satellite 120-a may promote variation in round trip delay. As a result, the UE 115-a may experience variation in uplink timing synchronization with the satellite 120-a. Likewise, the gateway 105-a may experience variation in uplink and downlink timing synchronization with the satellite 120-a. Thus, a total propagation delay may be comprised of a first portion of the propagation delay and a first propagation delay variation for the UE-to-satellite link, and a second portion of the propagation delay and a second propagation delay variation for the satellite-to-gateway link. In some cases, round trip delay information may include a satellite-to-gateway propagation delay, where the UE determines a UE-to-satellite propagation delay, and where the propagation delay variation is determined based on a duration in which a plurality of propagation delays are determined.

By way of example, the satellite 120-a may be in an orbit, such as low earth orbit, medium earth orbit, or non-geostationary earth orbit. In any of these examples, the satellite 120-a may be many thousands of kilometers from earth, and therefore may be thousands of kilometers from the gateway 105-a and the UE 115-a. Each transmission 205 or 210 between the gateway 105-a and the UE 115-a may therefore travel from earth the distance to the satellite 120-a and back to earth. The distance that a transmission travels may increase the propagation delay of a transmission or round trip delay associated with the transmission. The propagation delay may refer to a duration it takes for a signal to travel from a source to an intended recipient. The round trip delay may refer to a duration it takes for a transmission to be transmitted from the source to the intended recipient, processed by the intended recipient, and a response transmitted from the intended recipient of the transmission back to the source.

The UE 115-a may support a closed-loop timing control to maintain an uplink timing synchronization (or uplink timing accuracy) with the satellite 120-a, or with the gateway 105-a. The UE 115-a, in some examples, may rely on network signaled round trip delay information or a round trip delay variation rate (e.g., of a beam center of the satellite 120-a) when the UE 115-a is unable to determine its geolocation within the geographic coverage area 110-a. When the satellite 120-a is in a low-earth orbit, the satellite 120-a may be between 600 km to 2000 km from earth and travelling at a rate of 7.5 km/s. In the example of a low earth orbit location of the satellite 120-a, for example, such as a 1200 km orbit from earth with an elevation angle of 30° the round trip delay variation rate may be on the order of 35 microseconds (μs) per second(s) (μs/s).

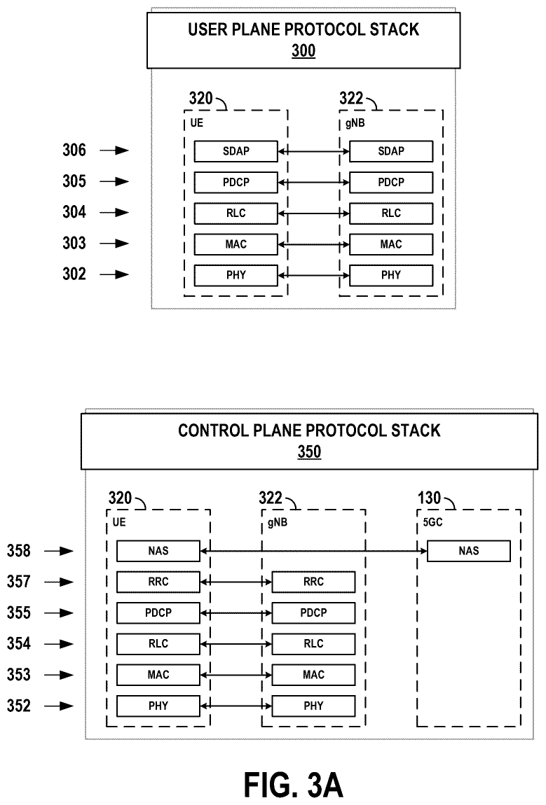

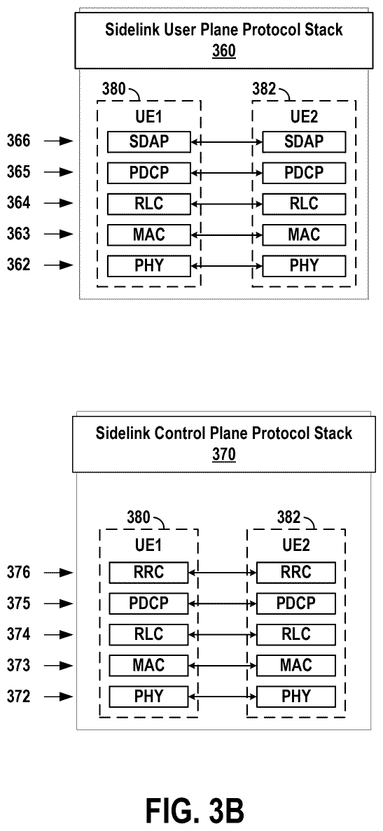

In order to provide synchronized uplink and downlink timing at the gateway 105-a, communications to and from the gateway 105-a may be made according to a gateway 105-a timing reference. The UE 115-a may adjust a timing of uplink communications to the gateway 105-a such that the uplink communication is transmitted far enough in advance of a timing boundary or frame boundary at the gateway 105-a to have a time of arrival at the gateway 105-a that corresponds to the timing boundary or frame boundary. In other cases, the UE 115-a may use a satellite 120-a timing reference for uplink communications, such that uplink communications are received at the satellite 120-a at a desired time or frame boundary. In either case, the satellite 120-a may have a sufficient propagation delay variation that the UE 115-a uplink timing may be based on the propagation delay and the propagation delay variation. FIG. 3 illustrates an example of a gateway timing reference in accordance with various aspects of the disclosure, with the understanding that such relative timing references may be applied in cases where the satellite timing reference is used for determination of uplink transmission timing.

FIG. 3A is a schematic illustration of a user plane protocol stack 300 and a control plane protocol stack 350 in accordance with some aspects of this disclosure. In a wireless telecommunication system, the communication protocol architecture may take on various forms depending on the application. For example, in a 3GPP NR system, the signaling protocol stack is divided into Non-Access Stratum (NAS 358) and Access Stratum (AS 302-306 and 352-357) layers and protocols. A NAS protocol 358 provides upper layers, for signaling between UE 320 and core network 130 (referring to FIG. 1). The AS protocol 302-306 and 352-357 provides lower layers, for signaling between base station 322 (e.g., a gNB, network node, or scheduling entities) and UE 320 (e.g., a scheduled entity).

Radio bearers between a network node (e.g., one of scheduling entities) and a scheduled entity may be categorized as data radio bearers (DRB) for carrying user plane data, corresponding to user plane protocol stack 300; and signaling radio bearers (SRB) for carrying control plane data, corresponding to control plane protocol stack 350.

In the AS, protocols of both user plane protocol stack 300 and control plane protocol stack 350 may include a physical layer (PHY) 302/352, a medium access control layer (MAC) 303/353, a radio link control layer (RLC) 304/354, and a packet data convergence protocol layer (PDCP) 305/355. PHY 302/352 is the lowest layer and implements various physical layer signal processing functions. MAC layer 303/353 provides multiplexing between logical and transport channels and is responsible for various functions. For example, the MAC layer 303/353 is responsible for reporting scheduling information, priority handling and prioritization, and error correction through hybrid automatic repeat request (HARQ) operations. RLC layer 304/354 provides functions such as sequence numbering, segmentation and reassembly of upper layer data packets, and duplicate packet detection. PDCP layer 305/355 provides functions including header compression for upper layer data packets to reduce radio transmission overhead, security by ciphering the data packets, and integrity protection and verification.

In user plane protocol stack 300, a service data adaptation protocol (SDAP) layer 306 provides services and functions for maintaining a desired quality of service (QoS). In control plane protocol stack 350, a radio resource control (RRC) layer 357 includes a quantity of functional entities for routing higher layer messages, handling broadcasting and paging functions, establishing and configuring radio bearers, NAS message transfer between NAS and UE, etc.

NAS protocol 358 provides for a wide variety of control functions between UE 320 and core network 130. These functions include, for example, registration management functionality, connection management functionality, and user plane connection activation and deactivation.

Sidelink communication may be provided over a PC5 interface, which employs PC5 protocols for D2D communication. Other suitable protocols may be utilized for sidelink communication within the scope of this disclosure.

Resource allocation for wireless resources in a sidelink resource pool may employ one of two modes, referred to herein as mode 1 and mode 2. In mode 1, which may be referred to as scheduled resource allocation, the sidelink resource allocation is provided by the radio access network (RAN). In mode 2, which may be referred to as UE autonomous resource allocation, a UE decides the sidelink transmission resources and timing in the sidelink resource pool.

Sidelink communication may employ several physical channels and physical signals. For example, a physical sidelink control channel (PSCCH) may be used to indicate resources and other transmission parameters that a UE uses for transmission of data on a physical sidelink shared channel (PSSCH). Transmission via the PSCCH may generally include a DM-RS.

Sidelink radio bearers may be categorized into two groups: sidelink data radio bearers for user plane data and sidelink signaling radio bearers for control plane data. FIG. 3B is a schematic illustration of a sidelink user plane protocol stack 360 and a sidelink control plane protocol stack 370 for a sidelink interface between a pair of UEs 115 in accordance with some aspects of this disclosure. The sidelink radio protocol architecture is illustrated in FIG. 3B with sidelink user plane protocol stack 360 and sideline control plane protocol stack 370, showing their respective layers or sublayers. Radio bearers between UEs 115 may be categorized as data radio bearers (DRB) for carrying user plane data, corresponding to sidelink user plane protocol stack 360; and signaling radio bearers (SRB) for carrying control plane data, corresponding to sidelink control plane protocol stack 370.

Both sidelink user plane protocol stack 360 and sidelink control plane protocol stack 370 include a physical (PHY) layer 362/372, a MAC layer 363/373, a RLC layer 364/374, and a PDCP layer (PDCP) 365/375. PHY layer 362/372 is the lowest layer and implements various physical layer signal processing functions. MAC layer 363/373 provides radio resource selection, packet filtering, priority handling between UL and DL transmissions for a given UE, and sidelink channel state information (CSI) reporting. RLC layer 364/374 provides functions such as sequence numbering, segmentation and reassembly of upper layer data packets, and duplicate packet detection. PDCP layer 365/375 provides functions including header compression for upper layer data packets to reduce radio transmission overhead, security by ciphering the data packets, and integrity protection and verification.

In sidelink user plane protocol stack 360, a service data adaptation protocol (SDAP) layer 366 provides services and functions for maintaining a desired quality of service (QoS), including mapping between a QoS flow and a sidelink data radio bearer. QoS broadly refers to the collective effect of service performances which determine the degree of satisfaction of a user of a service. QoS is characterized by the combined aspects of performance factors applicable to all services, such as: service operability performance; service accessibility performance; service retainability performance; service integrity performance; and other factors specific to each service.

In sidelink control plane protocol stack 370, a radio resource control (RRC) layer 376 includes a quantity of functional entities for transferring RRC messages between paired UEs 380, 382, for maintenance and release of an RRC connection between UEs 380, 382, and for detection of a sidelink radio link failure.

An RRC layer corresponding to a Uu interface (i.e., a radio interface between a radio access network and UE) also may include various sidelink-specific services and functions. For example, using the Uu interface, an RRC entity may configure sidelink resource allocation via system information signaling or dedicated signaling. This RRC entity may further be used for measurement configuration and reporting related to the sidelink, and for communication or reporting of UE assistance information relating to sidelink traffic patterns. That is, a UE may report sidelink traffic patterns to the RAN.

Sidelink communications may be supported by a source identifier (ID) and a destination identifier (ID). For example, a source layer-2 ID may identify the source, or sender of sidelink data. A destination layer-2 ID may identify the target, or receiver of sidelink data. Further, a PC5 link ID may be used to uniquely identify a PC5 unicast link in a UE for the lifetime of the PC5 unicast link.

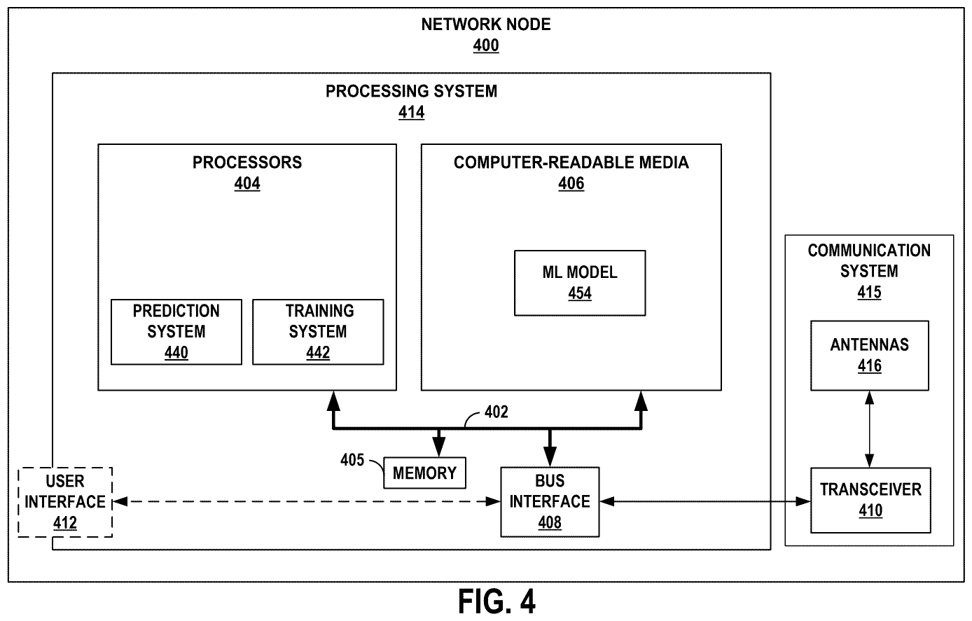

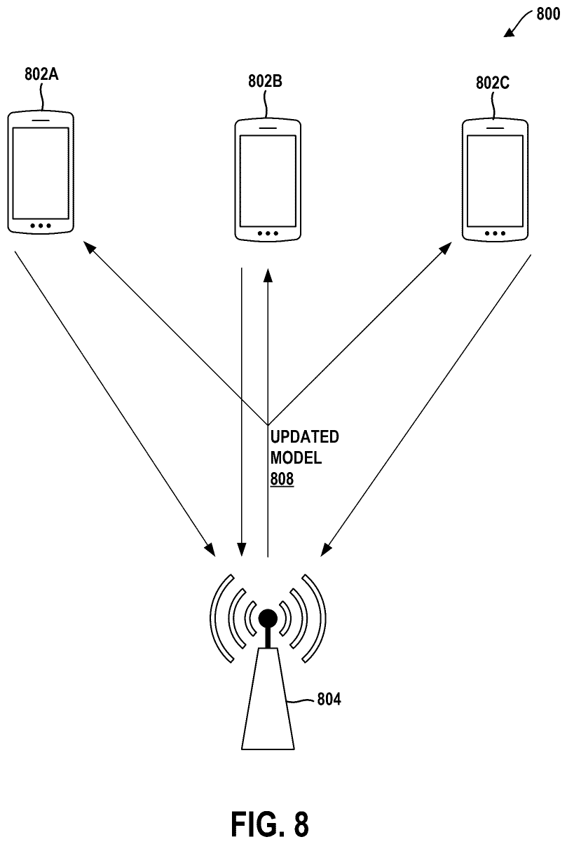

FIG. 4 is a block diagram illustrating an example of a hardware implementation for a network node 400, in accordance with one or more techniques of this disclosure. For example, network node 400 may be a scheduled entity, such as user equipment (UE), or a scheduling entity, such as a base station or gNB. Network node 400 may be a client device (e.g., one of client devices 802) or a central device (e.g., central device 804) of system 800 shown in FIG. 8.

Network node 400 includes a bus 402, one or more processors 404, a memory 405, one or more computer-readable media 406, a bus interface 408, a user interface 412, and a communication system 415. Communication system 415 may include a transceiver 410 and one or more antennas 416. A processing system 414 of network node 400 may incorporate bus 402, processors 404, memory 405, one or more computer-readable media 406, and bus interface 408.

Examples of processors 404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, network node 400 may be configured to perform any one or more of the functions described herein. For example, processors 404, as utilized in network node 400, may be configured (e.g., in coordination with a memory 405) to implement any one or more of the processes and procedures described in this disclosure.

Processing system 414 may be implemented with a bus architecture, represented generally by bus 402. Bus 402 may include any number of interconnecting buses and bridges depending on the specific application of processing system 414 and the overall design constraints. Bus 402 communicatively couples together various circuits including one or more processors (represented generally by processors 404), memory 405, and one or more computer-readable media (represented generally by computer-readable media 406). Bus 402 may also link various other circuits such as timing sources, peripherals, voltage regulators, and power management circuits, which are well known in the art, and therefore, will not be described any further. A bus interface 408 provides an interface between bus 402 and a transceiver 410. Transceiver 410 provides a communication interface or means for communicating with various other apparatus over a transmission medium. Depending upon the nature of the apparatus, a user interface 412 (e.g., keypad, display, speaker, microphone, joystick) may also be provided. User interface 412 is optional, and some examples, such as a base station, may omit it.

In some aspects of the disclosure, processors 404 may implement a prediction system 440 configured (e.g., in coordination with memory 405) for various functions, including applying a ML model to model input data to generate model output data. Processors 404 may also implement a training system 442 configured to train the ML model. In some examples, processors 404 may include special-purpose circuitry for implementing one or more of prediction system 440 and training system 442. In some examples, processors 404 may execute processor-executable instructions that cause processors 404 to implement one or more prediction system 440 and training system 442. Memory 405 and/or computer-readable media 406 may store such processor-executable instructions.

Processors 404 may be responsible for managing bus 402 and general processing, including the execution of software stored on computer-readable media 406. The software, when executed by processors 404, causes processing system 414 to perform the various functions described below for any particular apparatus. Processors 404 may also use computer-readable media 406 and memory 405 for storing data that processors 404 manipulate when executing software.

Processors 404 in processing system 414 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on computer-readable media 406. Computer-readable media 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. Computer-readable media 406 may reside in processing system 414, external to processing system 414, or distributed across multiple entities including processing system 414. Computer-readable media 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, computer-readable storage medium 406 may store computer-executable code that includes instructions that configure network node 600 for various functions, including applying an ML model and training the ML model. For example, the instructions may be configured to cause network node 400 to implement the techniques of this disclosure as either a client device or a central device. Computer-readable storage medium 406 may also store data representing a ML model 454.

In the above examples, the circuitry included in processors 404 is merely provided as an example, and other means for carrying out the described functions may be included within various aspects of the present disclosure, including but not limited to the instructions stored in the computer-readable storage medium 406, or any other suitable apparatus or means described elsewhere in this disclosure.

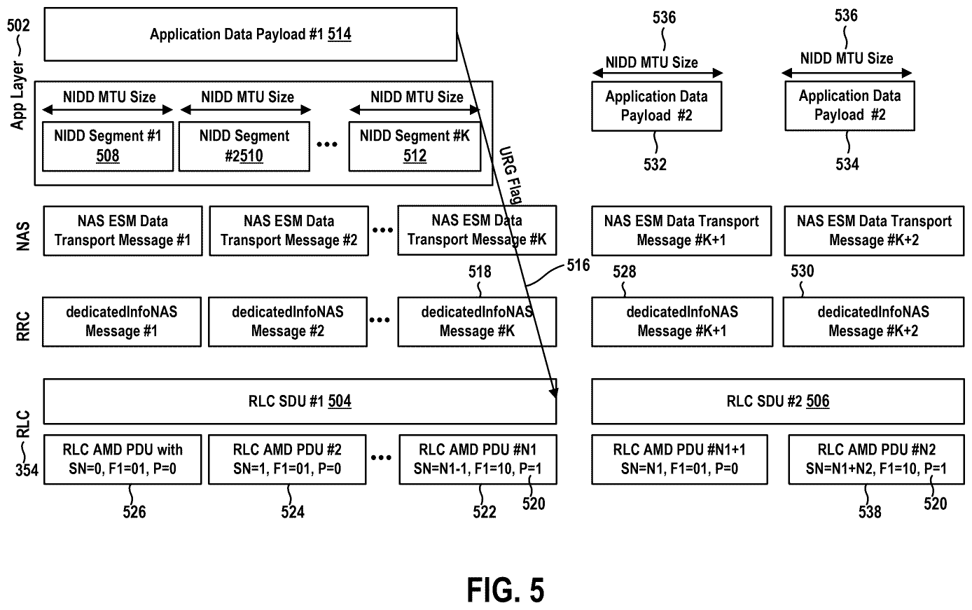

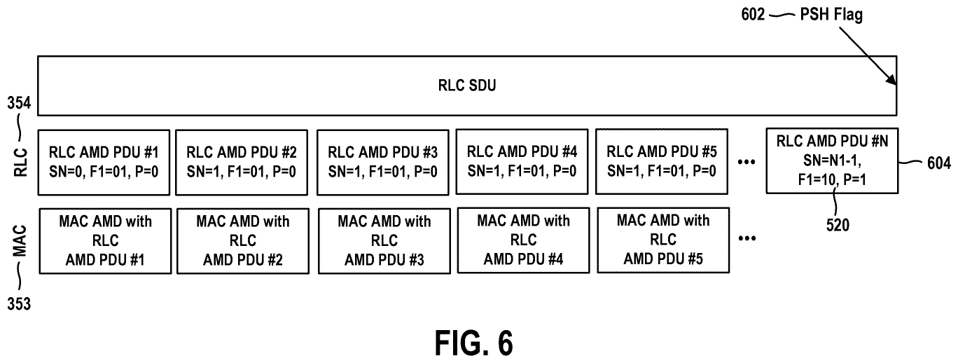

FIG. 5 is a conceptual diagram illustrating an example signal generation process in a non-terrestrial communication system that enhances an interface between the application layer and the RLC layer, in accordance with one or more techniques of this disclosure. In the example of FIG. 5, the application layer 502 may have control over how RLC 354 constructs Service Data Units (SDUs) 504, 506. This may be achieved by the application layer 502 sending metadata to the RLC layer 354 with specific instructions on how to group data within RLC SDUs 504, 506. The application layer 502 may send metadata to the RLC layer 354 to request that each RLC SDU 504, 506 contain only NIDD segments 508-512 or application payload 514 belonging to a single application. Application driven RLC-SDU formation may better ensure that data from different applications or different segments of the same application are not mixed within a single RLC SDU 504, 506. When the application layer 502 signals the PSH flag 602 (shown in FIG. 6) to the RLC layer 354, the PSH flag 602 may indicate that the current data should be transmitted as quickly as possible. RLC layer 354 may prioritize the immediate transmission of the current RLC SDU 504 containing the data marked with the PSH flag 602. When the application layer 502 signals the URG flag 516 to the RLC layer 354, the URG flag 516 may signify that the accompanying dedicatedInfoNAS RRC message 518 has high priority. RLC layer 354 may treat this message 518 as the last message to be included in the current RLC SDU 504. The URG flag 516 may better ensure that the urgent message is transmitted quickly and received by the network promptly. By ensuring that data from different applications or segments of the same application are not mixed within a single RLC SDU 504, the disclosed techniques may help to maintain data integrity and prevent out-of-order delivery. For applications sensitive to timing, such as real-time applications, the disclosed techniques may significantly reduce jitter by ensuring that data belonging to a specific application or segment is delivered in a timely and predictable manner.

When the application layer 502 signals the URG flag 516 to the RLC layer 354, the URG flag 516 may indicate that the accompanying dedicatedInfoNAS RRC message 518 has high priority and needs to be transmitted urgently. The URG flag 516 may instruct the RLC layer 354 to treat the marked RRC message 518 as the last message to be included in the current RLC SDU 504, regardless of whether the RLC SDU 504 is fully filled with other data. In addition to treating the marked message as the last in the RLC SDU 504, the RLC layer 354 may be instructed to set the poll bit 520 in the last RLC AMD PDU 522 (associated with this RLC SDU 504) before submitting that AMD PDU 522 to the lower layer. The poll bit 520 setting may trigger an immediate acknowledgement from the receiver UE. Faster acknowledgment may provide the transmitter with quicker feedback on the successful delivery of the urgent message. Faster feedback may allow for quicker retransmissions in case of errors, improving the reliability of urgent data delivery. The URG flag 516 may better ensure that the urgent message is not delayed by waiting for other data to fill the RLC SDU 504. The poll bit 520 setting may accelerate the acknowledgement process, enabling faster feedback and potentially reducing retransmissions. This mechanism may prioritize the delivery of urgent messages, improving the overall responsiveness of the system.

Non-Terrestrial Networks (NTN), such as those utilizing satellites 120, inherently suffer from high latency due to the long distances involved in signal propagation. This high latency, coupled with potential variations in signal delays, may lead to significant jitter. Jitter refers to the variation in arrival times of data packets, which may severely impact real-time applications like voice calls, video streaming, and industrial automation. By better ensuring that RLC SDUs 504, 506 containing critical or time-sensitive data are transmitted promptly, the proposed techniques may minimize the time spent waiting for other data to fill the corresponding RLC SDU 504, 506. This may help to reduce variations in delivery times, thereby minimizing jitter. The immediate transmission of critical data, triggered by the PSH flag 602 and URG flag 516, may significantly reduce the time it takes for the data to reach the receiver UE. This reduction may directly translate to lower overall latency for time-sensitive applications.

The disclosed techniques may be effectively applied to the uplink path as well. In uplink scenarios, the techniques may prioritize the transmission of critical control messages or data from delay-sensitive applications. Reduced latency and jitter in the uplink direction may significantly improve the user experience for applications like voice calls, video conferencing, and remote control.

The disclosed techniques may prioritize and expedite the delivery of critical data by influencing how the RLC layer 354 constructs RLC SDUs 504, 506. When the application layer 502 signals the URG flag 516 to the RLC layer 354, regardless of whether the RLC SDU 504 is fully filled or not, the RLC layer 354 may set the poll bit 520 in the last RLC AMD PDU 522 used to transmit this RRC message 518. The URG flag 516 may better ensure immediate transmission of the urgent message and may trigger a faster acknowledgement from the receiver UE. However, when the application layer 502 signals the PSH flag 602 to the RLC layer 354, the setting of the poll bit 520 may be conditional and may depend on the predicted RLC Uplink Block Error Rate (BLER). If the predicted RLC UL BLER exceeds a threshold (THR), the RLC layer 354 may set the poll bit 520 in the last RLC AMD PDU 522 used to transmit this RRC message 518. The disclosed techniques may better ensure timely delivery of urgent messages and data marked with the PSH flag 602. The disclosed techniques may minimize delays by triggering immediate transmission and faster acknowledgements. The disclosed techniques may reduce variations in delivery times, leading to smoother data flow for time-sensitive applications. The conditional poll bit 520 setting for the PSH flag 602 may allow for more efficient resource utilization by avoiding unnecessary polling in good channel conditions.

Setting the poll bit 520 when the RLC transmission/retransmission (Tx/reTx) buffer might not be empty could potentially lead to increased overhead due to more frequent RLC DL CTRL PDUs with STATUS PDU because the poll bit 520 essentially requests an immediate acknowledgement, which may increase signaling traffic. However, in the context of NB-NTN for advanced SOS (emergency messaging) or urgent use cases, this potential inefficiency may be justified by the critical need for rapid feedback and timely delivery. SOS or urgent messages often require the transmission of multiple NIDD segments 508-512. These NIDD segments 508-512 may be distributed across multiple RLC SDUs 504-506. By setting the poll bit 520 in the last RLC AMD PDU 522 containing the last NIDD segment 512 of the application data payload 514, the user/application on the UE side may be immediately notified of its successful delivery. If any RLC AMD PDUs 522-526 containing NIDD segments 508-512 of the application payload 514 are lost or corrupted, the faster acknowledgement mechanism may enable quicker retransmissions. This may be important for time-sensitive applications like SOS, where rapid response is important. While there is a potential trade-off between increased signaling overhead and faster feedback, the benefits of immediate notification and faster retransmissions may significantly outweigh the drawbacks for critical applications like SOS and other urgent use cases over NB-NTN. To mitigate the potential for excessive signaling, thresholds could be dynamically adjusted based on factors such as, but not limited to, network load, channel conditions, and the urgency level of the application.

The RLC layer 354 immediately transmits the current RLC SDU 504, even if the current RLC SDU 504 is not fully filled with data. The RLC layer 354 may not wait for additional dedicatedInfoNAS messages 528-530 (containing NIDD segments for subsequent application data payloads 532-534) to fill the current RLC SDU 504, even if the determined RLC SDU size by the lower layer could accommodate them. This may better ensure that the urgent data is transmitted promptly without unnecessary delays. Irrespective of the RLC Tx/reTx buffer status (empty or not), the RLC layer 354 may set the poll bit 520 in the last RLC AMD PDU 522 of the current RLC SDU 504. The poll bit 520 setting may trigger an immediate acknowledgement from the receiver UE, providing faster feedback on the successful delivery of the urgent data. This prioritized delivery technique may prioritize the urgent data by ensuring immediate transmission of the urgent data and requesting a quick acknowledgement. By minimizing delays and enabling faster feedback, the disclosed techniques may contribute to lower overall latency for urgent applications.

In the disclosed techniques, the RLC layer 354 may adopt a more granular approach to SDU formation. When a new application payload 532 or a subsequent part of an application payload (with a size smaller than the Maximum Transmission Unit-MTU size 536) arrives, the RLC layer 354 may create a new and separate RLC SDU 506 specifically for that data. This may better ensure that data from different applications or different segments of the same application are not mixed within a single RLC SDU. In the context of Narrowband Internet of Things (NB-IoT) over Non-Terrestrial Networks (NB-NTN), the poll bit 520 may be set in the last AMD PDU 538 of the RLC SDU 506 under a specific condition-if the RLC Tx/reTx buffer is empty. In other words, the poll bit 520 may be set if there are no other RLC SDUs 506 waiting to be transmitted. Creating separate RLC SDUs 504, 506 for each application payload 514, 532, 534 or segments of each application payload 514, 532, 534 may enhance data integrity by preventing intermixing of data from different sources. While this technique offers benefits in terms of data integrity and jitter reduction, this technique might introduce some overhead due to the creation of multiple small RLC SDUs 506.

FIG. 6 is a conceptual diagram illustrating an example signal generation process in a non-terrestrial communication system that that employs a machine learning model for RLC SDU construction based on a push flag, in accordance with one or more techniques of this disclosure. When the application layer 502 signals the PSH (push) flag 602 to the RLC layer 354, the PSH flag 602 may indicate that the associated data requires prioritized delivery. The RLC layer 354 may set the poll bit 520 in the last RLC AMD PDU 522 of the current RLC SDU 504 only if a condition is met. The condition may be based on the predicted RLC Uplink Block Error Rate (UL BLER). In an aspect, an ML model 454 (e.g., Multi-Layer Perceptron-MLP) may be trained to predict the RLC UL BLER. The ML model 454 may use historical data such as, but not limited to: HARQ BLER DL/UL, HARQ Retransmission/Failure rates, RLC Retransmission rates, RLC BLER DL/UL. If the predicted RLC UL BLER exceeds a preconfigured threshold, the RLC layer 354 may set the poll bit 520 in the last RLC AMD PDU 604. By setting the poll bit 520 only when necessary (i.e., when the predicted BLER is high), the disclosed system may avoid unnecessary signaling traffic and may reduce overall system overhead. The disclosed techniques may optimize resource utilization by minimizing the number of acknowledgements requested from the network.

In good channel conditions with low error rates (low HARQ Retx/failure rates, low RLC Retx rates), setting the poll bit 520 for every PSH-flagged transmission would generate frequent acknowledgements. In other words, setting the poll bit 520 for every PSH-flagged transmission may lead to increased signaling overhead, consuming valuable airtime and potentially impacting the performance of other devices. Unnecessary polling may consume valuable resources at both the transmitter UE and receiver UE. Setting the poll bit 520 strategically only when the predicted RLC BLER UL is high (indicating poor channel conditions) may better ensure that resources are used effectively. By focusing on scenarios where errors are more likely to occur (high HARQ Retx/failure rates, high RLC Retx rates, and expected RLC holes/gaps), the disclosed system may proactively request acknowledgements and minimize the impact of potential data loss. Setting the poll bit 520 for non-urgent applications with the PSH flag 602 should be a carefully considered decision. The poll bit 520 should only be triggered when the predicted RLC BLER UL indicates a high probability of errors, ensuring that resources are used efficiently and that the system may proactively address potential data loss. The threshold for setting the poll bit 520 should be dynamically adjusted based on real-time channel conditions, network load, and other relevant factors.

Frequent acknowledgements may consume valuable airtime and resources. Unnecessary polling may drain resources at both the transmitter UE and receiver UE, impacting overall network efficiency. The ML model 454 may predict the BLER UL based on historical data, such as, but not limited to: HARQ-RTT, HARQ BLER DL/UL, RLC BLER DL/UL. The HARQ_RTT may reflect the latency of the Hybrid ARQ (Automatic Repeat reQuest) process, providing insights into channel conditions. The HARQ BLER DL/UL may represent historical error rates on both downlink and uplink, indicating overall channel quality. The RLC BLER DL/UL may represent historical RLC error rates, providing specific information about RLC layer 354 performance. The SNR may represent Signal-to-Noise Ratio, a direct measure of channel quality. The poll bit 520 may be set by RLC layer 354 only if the predicted RLC BLER UL exceeds a pre-configured threshold (THR). This setting may better ensure that polling is triggered only when necessary, i.e., when the channel conditions are poor and the likelihood of errors is high. The disclosed techniques may minimize unnecessary acknowledgements, conserving valuable airtime and resources. The disclosed techniques may also optimize resource utilization by focusing polling efforts on scenarios where the polling efforts are most beneficial.

When RLC layer 354 blindly sets the poll bit 520 for all PSH-flagged transmissions, even when RLC holes/gaps are not expected and the Tx buffer of RLC layer 354 is not empty, the poll bit 520 may trigger the receiving UE to prematurely send a STATUS PDU back to the transmitting UE. The premature send of the STATUS PDU may happen because the poll bit 520 requests an immediate acknowledgement. If the channel is good, no RLC holes are expected, and the Tx buffer is not empty, this immediate acknowledgement may be unnecessary and wasteful. To address the aforementioned issue, the ML model 454 may predict the RLC BLER UL based on factors like HARQ_RTT, HARQ BLER DL/UL, RLC BLER DL/UL, and SNR. If the predicted RLC BLER UL exceeds a pre-configured threshold, the ML model 454 may indicate that potential holes/gaps in the reception of AMD PDUs at the receiving UE side are expected. If the predicted RLC BLER UL exceeds the threshold, the RLC layer 354 may set the poll bit 520, requesting an acknowledgement. Setting the poll bit 520 may be important in error-prone scenarios to ensure timely retransmissions.

In an aspect, the disclosed techniques may leverage Predictive Best Access (PBA) framework to further enhance the system. PBA may be integrated with a zone-based framework, where the UE's location and time of day (ToD) may be used to predict future network conditions. The PBA framework may utilize input parameters from on-device modern history database and/or cloud-based database. The on-device modem history database may store past performance data, including, but not limited to, channel quality, error rates, and latency. The cloud-based database may provide broader network-wide information, such as, but not limited to, traffic patterns, congestion levels, and cell performance. By incorporating these additional data sources, the PBA framework may refine the RLC BLER UL predictions, leading to more accurate and informed decisions about poll bit setting. More accurate RLC BLER UL predictions may lead to more precise poll bit 520 setting, further minimizing unnecessary signaling and improving resource utilization. The disclosed system may proactively adapt to changing network conditions, ensuring optimal performance across different locations and times.

As noted above, the ML model 454 may predict the BLER UL to determine the likelihood of data loss. This prediction may also consider UE movement and may leverage historical data (from the UE itself or other UEs in similar conditions) to improve accuracy. The disclosed techniques may account for the impact of mobility on channel conditions (e.g., fading, interference). The disclosed techniques may utilize past experiences of the current UE or other UEs operating in the same or similar conditions (e.g., time of day, location) to refine predictions. The poll bit 520 may be set only if the predicted RLC BLER UL exceeds a pre-configured threshold (THR). This may avoid unnecessary signaling overhead in good channel conditions. By considering UE movement and leveraging historical data, the RLC BLER UL prediction may become more accurate. For URGENT applications, immediate acknowledgements may better ensure low latency and high reliability.

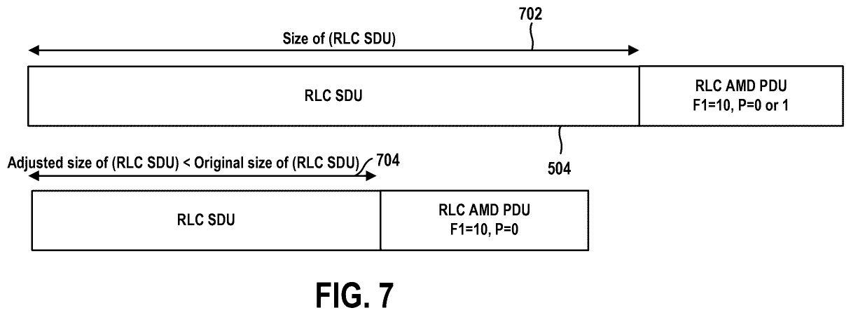

FIG. 7 is a conceptual diagram illustrating an example system that employs a machine learning model for RLC SDU size determination in NTN environments where Global Navigation Satellite Systems (GNSS) signal degradation may impact communication, in accordance with one or more techniques of this disclosure. The significant propagation delay over long distances in NTN may introduce substantial variations in Timing Advance (TA), the time offset required to align the uplink transmissions of UE 380, 382 with the timing of NTN. Doppler shifts and other propagation effects may cause significant frequency offsets, degrading signal quality and disrupting communication. To address these challenges the UEs 380, 382 may need to autonomously adjust for TA and frequency shifts to maintain reliable communication. Generally, Global Navigation Satellite Systems (GNSS) (like GPS, Galileo) may provide accurate location and timing information, enabling UEs 380, 382 to calculate and compensate for propagation delays. The network may broadcast information about the position, velocity, and other relevant parameters of satellite 120, which the UE 380, 382 may utilize for more precise timing and frequency adjustments. However, if GNSS is unavailable, the UE 380, 382 may need to disconnect from the network, acquire a GNSS fix, and then reconnect to ensure accurate timing and frequency synchronization.

In NTN, UEs 380, 382 may rely on GNSS for accurate timing and frequency synchronization. If the GNSS signal is lost or degraded, the synchronization capabilities of UEs 380. 382 may deteriorate, potentially leading to communication disruptions. A GNSS-validity-timer may reflect the remaining time during which the current GNSS measurements may be considered valid. The remaining time on the GNSS-validity-timer may directly impact the allowable RLC SDU size 702. If the GNSS-validity timer is about to expire, transmitting large RLC SDUs 504 may increase the risk of: communication interruptions and unnecessary disconnections. The UE 380 may lose synchronization before the entire RLC SDU 504 can be transmitted, leading to data loss and the need for retransmissions. If the GNSS signal is lost before the RLC SDU 504 is transmitted, the UE 380 may need to disconnect, acquire a new GNSS fix, and then reconnect, significantly impacting communication latency and user experience. In an aspect, ML model 454 may be trained to predict the time required to transmit the entire RLC SDU 504. The ML model 454 may utilize various input parameters, such as but not limited to: HARQ_RTT, HARQ BLER DL/UL, RLC BLER DL/UL and SNR. The HARQ_RTT may reflect the latency of the HARQ process, providing insights into channel conditions. The HARQ BLER DL/UL may represent historical error rates on both downlink and uplink, indicating overall channel quality. The RLC BLER DL/UL may represent historical RLC error rates, providing specific information about RLC layer 354 performance. The SNR (Signal-to-Noise Ratio) may be a direct measure of channel quality. Based on the predicted transmission time and the remaining time on the GNSS-Validity-Timer, the RLC layer 354 may dynamically adjust 704 the RLC SDU size 702 to minimize the risk of communication interruptions and unnecessary disconnections. The disclosed techniques may reduce the likelihood of communication interruptions due to GNSS signal loss. The disclosed techniques may avoid unnecessary disconnections, improving user experience and reducing latency.

In NTN (Non-Terrestrial Networks) like NB-IoT NTN and NR NTN, UEs 380, 382 may face unique challenges due to the vast distances involved. The immense distances in NTN may result in significant propagation delays and Doppler shifts, impacting timing and frequency accuracy. UEs 380, 382 may autonomously pre-compensate for TA and frequency shifts to ensure accurate uplink transmissions. The NTN network may broadcast information about the position, velocity, and other relevant parameters about satellite 120, aiding in frequency shift compensation. If GNSS is unavailable, the UE 380, 382 may not accurately compensate for TA and frequency shifts. Incorrect timing may lead to data corruption and the need for retransmissions. When GNSS is unavailable, the UE 380 may tear down the existing Radio Resource Control (RRC) layer 376 connection. The UE 380 may actively search for and acquire a GNSS signal to obtain accurate location and timing information.

In dynamic environments, the GNSS signal may degrade over time, leading to inaccuracies in timing and frequency synchronization. Uplink transmissions may become misaligned, leading to data errors and the need for retransmissions. The RLC layer 354 should account for the remaining time on the GNSS-validity-timer when determining the size 702 of the RLC SDU 504, especially for advanced use cases involving multiple NIDD segments 508-512 for a single application payload 514. If the estimated transmission time exceeds the remaining time on the GNSS-validity-timer, the RLC layer 354 may adjust 704 (e.g., reduce) the size 702 of the current RLC SDU 504. The disclosed techniques may minimize the risk of communication interruptions due to GNSS signal degradation.

In NTN scenarios, where GNSS is important for timing and frequency synchronization, careful RLC SDU size determination may be important to prevent significant resource wastage. If the time required to transmit all AMD PDUs 522-526 within an RLC SDU 504, receive the corresponding STATUS PDUs, and retransmit any NACK-ed AMD PDUs exceeds the remaining time on the GNSS-validity-timer, the transmitting UE may face critical issues. In other words, the GNSS signal may degrade before the entire RLC SDU transmission and acknowledgement process is complete, leading to synchronization loss. To maintain accurate timing, the UE may be forced to tear down the RRC connection, flush all transmitted RLC AMD PDUs from its buffer (effectively discarding the data), and reacquire a GNSS fix before resuming communication. This process may result in significant latency and data loss. Transmitting and then discarding an entire RLC SDU 504 due to GNSS signal degradation may represent a significant waste of network resources, including, but not limited to: uplink bandwidth and processing power. The uplink bandwidth may be consumed by the transmitted AMD PDUs. The processing power may include power expended by both the UE and the network for transmission, reception, and potential retransmissions. By carefully determining the RLC SDU size 702, the disclosed system may better ensure that the entire RLC SDU 504 may be transmitted, acknowledged, and potentially retransmitted within the validity period of the current GNSS fix. Network resources may be utilized efficiently, minimizing wasted transmissions and improving overall system performance.

The disclosed techniques address the issue of RLC SDU size 702 determination in NTN environments where GNSS signal degradation may significantly impact communication. There may be multiple factors influencing transmission time. The amount of resources allocated by the network may significantly impact the time required to transmit the RLC SDU 504. These resources may include, but are not limited to: TBS, MCS, #RU, ACK/NACK rate and GNSS-validity timer. As noted above, TBS (Transport Block Size) may be the amount of data that may be transmitted within a single resource block. The MCS (Modulation and Coding Scheme) may determine the spectral efficiency of the transmission. The #RU (Number of Resource Units) may represent the total number of resource units allocated for transmission. The ACK/NACK rate may be the rate at which acknowledgements (ACKs) or negative acknowledgements (NACKs) are received and may provide insights into the channel quality and the likelihood of retransmissions. The remaining time on the GNSS-validity-timer may dictate the maximum allowable transmission time before potential synchronization loss. Factors accounting for RTT and retransmissions may include, but are not limited to: HARQ_RTT, HARQ BLER DL/UL, RLC BLER DL/UL and SNR. The HARQ_RTT may reflect the round trip time of the Hybrid ARQ process, providing insights into channel latency. The HARQ BLER DL/UL may represent historical error rates on both downlink and uplink, indicating the likelihood of transmission errors. The RLC BLER DL/UL may represent historical RLC error rates, providing specific information about RLC layer 354 performance. The SNR (Signal-to-Noise Ratio) may be a direct measure of channel quality.

In an aspect, ML model 454 may be trained to predict the time required to: transmit the entire RLC SDU, receive STATUS PDUs for all transmitted AMD PDUs, retransmit any NACK-ed AMD PDUs. This prediction should consider the aforementioned factors, including the remaining time on the GNSS-validity-timer. Based on the predicted transmission time and the remaining time on the GNSS-validity-timer, the RLC layer 354 may dynamically adjust 704 the RLC SDU size 702 to: 1) minimize the risk of exceeding the GNSS-validity-timer; 2) avoid unnecessary disconnections and resource wastage; 3) ensure timely and reliable data delivery. The ML model 454 may minimize the risk of communication interruptions due to GNSS signal degradation. The ML model 454 may avoid unnecessary disconnections, leading to a smoother and more efficient user experience. The ML model 454 may also prevent the transmission of large RLC SDUs 504 that may not be successfully delivered before the GNSS signal is lost.

Currently, the RLC layer 354 may not adequately consider factors like the time required for retransmissions due to errors (NACKs) when deciding on resource grants. The RLC layer 354 may currently consider factors like: UL Grant Rate (how frequently Uplink grants are being assigned), UL grant info (details within the grant), such as, but not limited to: TBS, MCS, #RU, ACK/NACK rate. In an aspect, the RLC layer 354 should also factor in the remaining time on the GNSS-validity-timer. The disclosed techniques may consider the time it takes to: 1) receive a STATUS PDU (which carries information about the success or failure of previously transmitted data) for the AMD PDUs 522-526 within the RLC SDU 504 and 2) retransmit any AMD PDUs 522-526 that were not successfully received (NACKed). In an aspect, the ML model 454 may be used to predict the total time required to send the entire RLC SDU 504 to the network. The ML model 454 may be trained on historical data and may use the following input parameters: HARQ_RTT; HARQ BLER; RLC BLER; and SNR. By considering the potential time required for retransmissions, the disclosed system may make more informed decisions about resource allocation, leading to more efficient use of available resources. Faster and more reliable data delivery may be achieved by minimizing the impact of retransmissions on overall transmission time. By optimizing resource usage, the overall throughput of the system may be improved.

The disclosed techniques may prevent situations where the time required to transmit and acknowledge RLC SDU 504 exceeds the remaining validity of the GNSS data used for positioning. This may better ensure that the positioning information remains accurate and reliable during the entire data transmission process. The ML model 454 may estimate the total time (T) required for the following: transmission of all RLC AMD PDUs 522-526 within the SDU 504, reception of the STATUS PDU (which indicates the successful or unsuccessful reception of each AMD PDU 522-526) and retransmission of any NACKed (not acknowledged) AMD PDUs. As noted above, this estimation may be based on factors like: historical HARQ_RTT, HARQ BLER, RLC BLER, SNR and current network conditions. ML model 454 may be employed to perform this prediction based on historical data and real-time observations. In an aspect, the ML model 454 may check the remaining time on the GNSS validity timer. This timer may indicate the period within which the current GNSS data is considered valid for positioning purposes. If remaining time on GNSS validity timer <T then: the RLC layer 354 may adjust 704 the size 702 of the RLC SDU 504. This adjustment may aim to better ensure that remaining time on GNSS validity timer >=T. In an aspect, the adjustment may involve: reducing the number of AMD PDUs 522-526 within the SDU 504; applying more aggressive error correction techniques to reduce the likelihood of retransmissions; and other strategies to minimize the overall transmission time. By better ensuring that GNSS data remains valid throughout the entire transmission process, the accuracy of positioning information may be maintained. Minimizing the transmission time may lead to faster position updates and improved overall system responsiveness. By optimizing the RLC SDU size 702, the disclosed system may avoid unnecessary delays and better ensure efficient use of network resources.

In summary, the disclosed techniques may improve the alignment of RLC SDUs 504 with application-level data segments. Specifically, the disclosed techniques may better ensure that each RLC SDU 504 contains Network Identification and Decoding (NIDD) segments 508-512 belonging exclusively to a single application payload 514. The application layer 502 may send metadata to the RLC layer 354 along with the data. This metadata may include a special flag, referred to herein as “URG” flag 516. The “URG” flag 516 may signal to the RLC layer 354 that the current RLC SDU 504 should be treated as a complete unit and not be combined with data from other application payloads 532, 534. When the RLC layer 354 receives RLC PDU 522 with the “URG” flag 516 set in the associated metadata: the RLC layer 354 may prioritize the transmission of this RLC SDU 504. The RLC layer 354 may avoid combining this RLC SDU 504 with data from other applications. The RLC layer 354 may better ensure that the RLC SDU 504 is transmitted as a single unit, preserving the integrity of the application payload 514. The disclosed techniques may employ ML model 454 to assist the RLC layer 354 in determining whether to complete RLC SDU 504 upon receiving a dedicatedInfoNAS RRC (Radio Resource Control) message 518 with the “URG” flag 516 from the application layer 502. The ML model 454 may analyze various factors, such as, but not limited to: network congestion levels; current buffer occupancy at the RLC layer 354; historical transmission success rates and predicted delay for transmitting the current RLC SDU 504. Based on these factors, the ML model 454 may predict whether immediate completion of the RLC SDU 504 is the most advantageous course of action, considering factors like minimizing latency and maximizing throughput. By aligning RLC SDUs 504 with application payload boundaries, the disclosed techniques may significantly improve application performance, especially for applications that are sensitive to data segmentation and reordering. Prioritizing and completing “URG” flagged RLC SDUs 504 may help reduce latency for time-critical applications. By optimizing RLC SDU boundaries, the disclosed system may achieve more efficient data transmission and potentially improve overall throughput.

The ML model 454 may utilize the following input features to make the aforementioned prediction: HARQ BLER DL/UL, The HARQ BLER DL/UL, HARQ Retx/failure rate, RLC Retx rate. The ML model 454 may predict whether the RLC layer 354 should complete the current RLC SDU 504 immediately upon receiving dedicatedInfoNAS RRC message 518 with the “URG” flag 516 from the application layer 502. By better ensuring that NIDD segments 508-512 belonging to single application payload 514 are transmitted together as single RLC SDU 504, the disclosed techniques may minimize the variability in transmission delays (jitter). This may be important for applications that are sensitive to timing variations, such as real-time control systems or applications requiring precise synchronization. By optimizing the transmission of NIDD segments 508-512 and minimizing unnecessary delays, the disclosed techniques may reduce the overall latency experienced by applications. The proposed techniques may avoid unnecessary overhead by better ensuring that RLC SDUs 504 are efficiently packed and transmitted. This may help to conserve valuable Over-The-Air (OTA) resources in resource-constrained NB-NTN environments. By minimizing jitter and latency, the disclosed techniques may contribute to improved QoS for applications operating over NB-NTN, leading to a more reliable and predictable user experience. The proposed ML model 454 and techniques may optimize the transmission of NIDD segments 508-512 in NB-NTN by: 1) leveraging application-level metadata to signal the importance of specific data segments; 2) utilizing ML model 454 to make informed decisions about RLC SDU completion based on historical data and real-time network conditions; and 3) minimizing jitter and latency while ensuring efficient use of valuable OTA resources.

FIG. 8 is a conceptual diagram illustrating an example system 800 that performs RLC SDU construction, in accordance with one or more techniques of this disclosure. In the example of FIG. 8, system 800 includes a plurality of client devices 802A-802C (collectively, “client devices 802”) and a central device 804. Client devices 802 may be UEs, scheduled entities, base stations (e.g., gNBs) or other types of devices. Central device 804 may be a gNB or another type of device.

Each of client devices 802 may host an individual instance of a ML model. For example, each of client devices 802 may store data describing a structure of the ML model 454 and values of parameters of the ML model 454. Similarly, central device 804 may store its own instance of the ML model 454. The ML model 454 may be one of a variety of different types of ML model. For example, the ML model 454 may be a Multi-Layer Perceptron (MLP) model and the parameters may be weights associated with inputs to artificial neurons of the ML model 454.

Client devices 802 may individually obtain model input data. Client devices 802 may apply their own instances of an ML model to the model input data to generate model output data. Client devices 802 may use the model output data for various purposes. For example, client devices 802 may obtain data indicating signal strengths of RF signals transmitted by a plurality of fixed-position network nodes, such as wireless base stations. In this example, each of client devices 802 may individually apply their own instances of the ML model 454 to generate model output data that indicates the likelihood of data loss by predicting the BLER UL, for example. In some such examples, if the predicted RLC BLER UL exceeds a threshold, the RLC layer 354 at client devices 802 may set the poll bit 520, requesting an acknowledgement. Setting the poll bit 520 may be important in error-prone scenarios to ensure timely retransmissions.

As an example, ML model 454 may take measurements of a reference signal as model input data to predict a channel characteristic associated with a different reference signal. The model input data may include, for example, measurements of one or more reference or pilot signals, such as HARQ_RTT, HARQ BLER DL/UL, RLC BLER DL/UL and SNR. The HARQ_RTT may reflect the latency of the HARQ process, providing insights into channel conditions. The HARQ BLER DL/UL may represent historical error rates on both downlink and uplink, indicating overall channel quality. The RLC BLER DL/UL may represent historical RLC error rates, providing specific information about RLC layer 354 performance. The SNR may be a direct measure of channel quality. The model output data may include, for example, BLER UL or an estimate of the total time (T) required for the following: transmission of all RLC AMD PDUs 522-526 within the SDU 504, reception of the STATUS PDU (which indicates the successful or unsuccessful reception of each AMD PDU 522-526) and retransmission of any NACKed (not acknowledged) AMD PDUs.

ML models 454 may be deployed in one or more devices (for example, network entities and user equipment (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc. In some examples, the model output data indicates a position of the client device.

Additionally, client devices 802 may individually train their instances of the ML model 454. For instance, in the example where the ML model 454 generates model output data indicating the RLC BLER DL/UL, client devices 802 may receive expected output data (e.g., ground truth information) that indicates actual RLC BLER DL/UL of client devices 802. For example, human users may provide input indicating the actual values RLC BLER DL/UL. Each of client devices 802 may apply an error function to the model output data and expected output data. The client device may calculate a gradient of the error function. In some examples, such as examples in which the ML model 454 is an auto-encoder, the expected output data may be the same as the model input data.

Furthermore, central device 804 may apply a backpropagation process that updates the values of the model parameters based on the gradient of the error function. The communication system of central device 804 may then transmit model update data 808 to client devices 802. The model update data 808 comprises data the enables client devices 802 to update their values of the model parameters

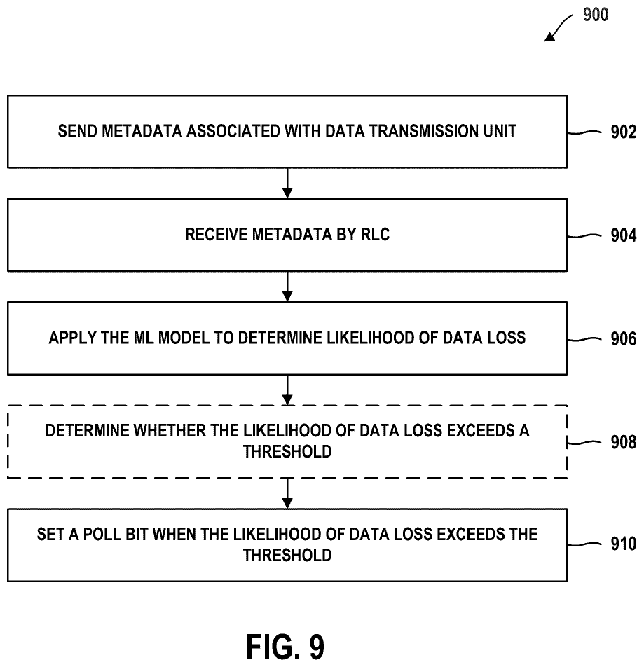

FIG. 9 is a flowchart illustrating an example process performed by client device 802A, in accordance with one or more techniques of this disclosure. The flowchart of FIG. 9 is described with respect to client device 802A but may be applicable with respect to any of client devices 802.

In the example of FIG. 9, client device 802A applies an ML model (e.g., ML model 454) to model input data to determine model output data. For example, the ML model 454 may comprise a Multi-Layer Perceptron (MLP) model. In this example, client device 802A may provide the model input data as input to artificial neurons of an input layer of the MLP model and perform a forward pass. In this example, artificial neurons of an output layer of the MLP model may output the model output data.

Additionally, an application layer of client device 802A may send metadata associated with one data transmission unit of a plurality of data transmission units indicating that the corresponding data transmission unit comprises a last data transmission unit associated with a particular application payload (902). This metadata may include a special flag, referred to herein as “URG” flag 516. The “URG” flag 516 may signal to the RLC layer 354 of client device 802A that the current RLC SDU 504 should be treated as a complete unit and not be combined with data from other application payloads 532, 534.

The RLC layer 354 of client device 802A may receive the metadata associated with the one data transmission unit (904). RLC layer 354 may prioritize the immediate transmission of the current RLC SDU 504 containing the data marked with the PSH flag 602. When the application layer 502 signals the URG flag 516 to the RLC layer 354, the URG flag 516 may signify that the accompanying dedicatedInfoNAS RRC message 518 has high priority. RLC layer 354 may treat this message 518 as the last message to be included in the current RLC SDU 504.

Furthermore, the RLC layer 354 of client device 802A may apply the ML model 454, using the historical values of the model parameters to determine likelihood of data loss (906). As noted above, in the example of FIG. 9, client device 802A may apply an ML model (e.g., ML model 454) to model input data to determine model output data. Each of the subcarriers corresponds to a different frequency. The ML model 454 may utilize historical data such as, but not limited to: HARQ BLER DL/UL, HARQ retransmission/failure rates, RLC retransmission rates.

Next, client device 802A may optionally determine whether the likelihood of data loss exceeds a threshold (908). If the likelihood of data loss (e.g., the predicted RLC BLER UL) exceeds the threshold, the ML model 454 may indicate that potential holes/gaps in the reception of AMD PDUs at the receiving client device (e.g., client device 802B) are expected. If the likelihood of data loss (e.g., the predicted RLC BLER UL) exceeds the threshold, the RLC layer 354 may set the poll bit 520 (910), requesting an acknowledgement from client device 802B. Setting the poll bit 520 may be important in error-prone scenarios to ensure timely retransmissions. If the likelihood of data loss does not exceed the threshold, the RLC layer 354 will not set the poll bit 520 in the transmitted AMD PDU. The transmission will proceed without the extra mechanism of requesting an explicit acknowledgment from the receiving client device 802B. This avoids unnecessary overhead in scenarios where the communication channel is considered reliable.

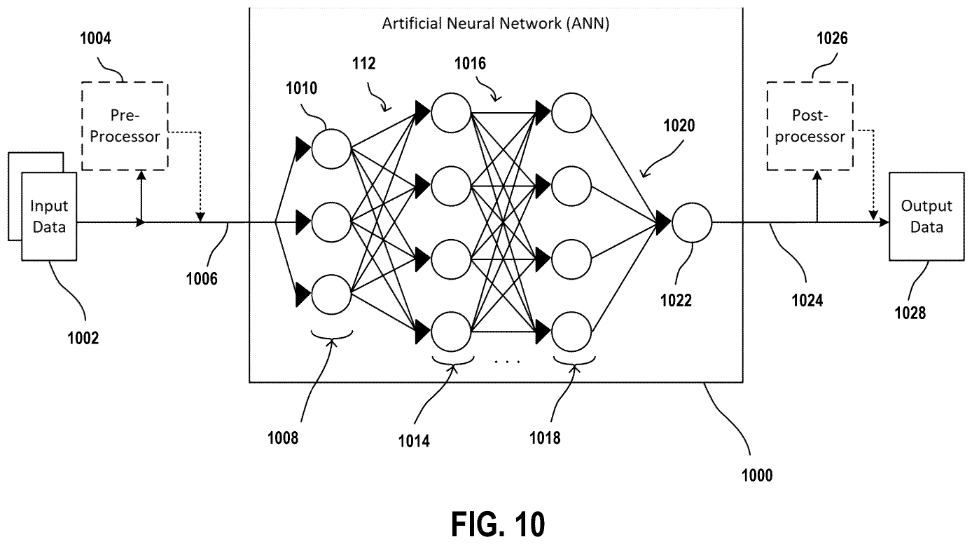

FIG. 10 is an illustrative block diagram of an example machine learning (ML) model represented by a Multi-Layer Perceptron (MLP) model 1000. The MLP 1000 may receive input data 1002 (i.e., model input data) which may include one or more bits of data, pre-processed data output from pre-processor 1004 (optional), or some combination thereof. Here, the data 1002 may include training data, verification data, application-related data, or the like, based, for example, on the stage of deployment of the MLP 1000. The pre-processor 1004 may be included within the MLP 1000 in some other implementations. The pre-processor 1004 may, for example, process all or a portion of the data 1002 which may result in some of the data 1002 being changed, replaced, deleted, etc. In some implementations, pre-processor 1004 may add additional data to data 1002. In some implementations, the pre-processor 1004 may be a ML model, such as an MLP.

The MLP 1000 includes at least one first layer 1008 of artificial neurons 1010 to process input data 1006 and provide resulting first layer data via connections or “edges” such as edges 1012 to at least a portion of at least one second layer 1014. The second layer 1014 processes data received via edges 1012 and provides second layer output data via edges 1016 to at least a portion of at least one third layer 1018. The third layer 1018 processes data received via the edges 1016 and provides third layer output data via edges 1020 to at least a portion of a final layer 1022 including one or more neurons to provide output data 1024. All or part of the output data 1024 may be further processed in some manner by (optional) post-processor 1026. Thus, in certain examples, the MLP 1000 may provide output data 1028 that is based on the output data 1024, post-processed data output from the post-processor 1026, or some combination thereof.

Post-processor 1026 may be included within the MLP 1000 in some other implementations. The post-processor 1026 may, for example, process all or a portion of the output data 1024 which may result in the output data 1028 being different, at least in part, to the output data 1024, as result of data being changed, replaced, deleted, etc. In some implementations, the post-processor 1026 may be configured to add additional data to the output data 1024. In this example, the second layer 1014 and the third layer 1018 represent intermediate or hidden layers that may be arranged in a hierarchical or other like structure. Although not explicitly shown, there may be one or more further intermediate layers between the second layer 1014 and the third layer 1018. In some implementations, the post-processor 1026 may be a ML model, such as an MLP.

The structure and training of the artificial neurons 1010 in the various layers may be tailored to specific requirements of an application. Within a given layer such as the first layer 1008, the second layer 1014, or the third layer 1018 of the MLP 1000, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of the MLP 1000. The weights and biases of the MLP 1000 may be adjusted during a training process or during operation of the MLP 1000. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 1006. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as the MLP 1000, may be conducted using training data. Training data may include one or more datasets which the MLP 1000 may use to identify patterns or relationships. Training data may represent various types of information, including written, visual, audio, environmental context, operational properties, etc. During training, the parameters (such as the weights and biases) of the artificial neurons 1010 may be changed, such as to minimize or otherwise reduce a loss function or a cost function. A training process may be repeated multiple times to fine-tune the MLP 1000 with each iteration.

The MLP 1000 or other ML models may be implemented in various types of processing circuits along with memory and applicable instructions therein. For example, general purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by a NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model.

In example aspects, an ML model may be trained prior to, or at some point following, operation of the ML model, such as the MLP 1000, on input data. When training the ML model, information in the form of applicable training data may be gathered or otherwise created for use in training an artificial neural network (ANN) accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within in a wireless communication system, or even shared (or obtained from) outside of the wireless communication system.

Once a MLP has been configured by setting parameters, including weights and biases, from training data, the MLP's performance may be evaluated. In some scenarios, evaluation/verification tests may use a validation dataset, which may include data not in the training data, to compare the model's performance to baseline or other benchmark information. The MLP configuration may be further refined, for example, by changing its architecture, retraining it on the data, or using different optimization techniques, etc.

As part of a training process, parameters affecting the functioning of the artificial neurons and layers may be adjusted. For example, backpropagation techniques may be used to train a MLP by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an MLP is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing a MLP to be trained on data collected from a wide range of devices and environments. For example, a MLP may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

The following is a non-limiting list of clauses in accordance with one or more techniques of this disclosure.
Clause 1. A device for communication in a non-terrestrial communication system, comprising: one or more memories configured to store historical values of model parameters of a machine learning (ML) model, and one or more processors are configured to: send, by an application layer, metadata associated with one data transmission unit of a plurality of data transmission units, the metadata indicating that the one data transmission unit comprises a last data transmission unit associated with a particular application payload; receive, by a Radio Link Control (RLC) layer, the metadata associated with the one data transmission unit; apply the ML model, using the historical values of the model parameters, to determine a likelihood of data loss; and set, by the RLC layer, a poll bit in the last data transmission unit when the likelihood of data loss exceeds a threshold.
Clause 2. The device of clause 1, wherein the likelihood of data loss is indicated by an RLC Block Error Rate (BLER) and wherein the ML model is trained to predict the RLC BLER on an uplink (UL) channel.
Clause 3. The device of clause 2, wherein the one or more processors, to determine whether the likelihood of data loss exceeds the threshold, are configured to determine whether the RLC BLER exceeds the threshold.
Clause 4. The device of any of clauses 1-3, wherein the historical values of the model parameters comprise historical values of one or more of: Hybrid Automatic Repeat reQuest-Round Trip Times (HARQ-RTT), HARQ BLER downlink (DL)/UL, RLC BLER DL/UL and Signal-to-Noise Ratio (SNR).
Clause 5. The device of any of clauses 1-4, wherein the metadata includes one or more of a push flag and an urgent flag and wherein the one or more processors are further configured to: transmit, by the RLC layer, the one data transmission unit to a receiver device, in response to receiving the urgent flag from the application layer.
Clause 6. The device of clause 5, wherein data contained in the one data transmission unit corresponds to one application payload.
Clause 7. The device of any of clauses 1-6, wherein the one or more processors are further configured to: apply the ML model using the historical values of the model parameters to determine a total time required for transmission and acknowledgement of the one data transmission unit based on current communication channel conditions.
Clause 8. The device of clause 7, the one or more processors are further configured to: compare, by the RLC layer, the total time with a time remaining on a timer indicating a maximum allowable transmission time before potential synchronization loss.
Clause 9. The device of clause 8, the one or more processors are further configured to: adjust, by the RLC layer, a size of the one data transmission unit, in response to determining that the total time exceeds the time remaining on the timer.
Clause 10. The device of any of clauses 1-9, wherein the device comprises a base station or a User Equipment (UE).
Clause 11. A method for communication in a non-terrestrial communication system, comprising: sending, by an application layer, metadata associated with one data transmission unit of a plurality of data transmission units, the metadata indicating that the one data transmission unit comprises a last data transmission unit associated with a particular application payload; receiving, by a Radio Link Control (RLC) layer, the metadata associated with the one data transmission unit; applying a Machine Learning (ML) model, using historical values of model parameters of the ML model, to determine a likelihood of data loss; and setting, by the RLC layer, a poll bit in the last data transmission unit when the likelihood of data loss exceeds a threshold.
Clause 12. The method of clause 11, wherein the likelihood of data loss is indicated by an RLC Block Error Rate (BLER) and wherein the ML model is trained to predict the RLC BLER on an uplink (UL) channel.
Clause 13. The method of clause 12, wherein determining whether the likelihood of data loss exceeds the threshold comprises determining whether the RLC BLER exceeds the threshold.
Clause 14. The method of any of clauses 11-13, wherein the historical values of the model parameters comprise historical values of one or more of: Hybrid Automatic Repeat reQuest-Round Trip Times (HARQ-RTT), HARQ BLER downlink (DL)/UL, RLC BLER DL/UL and Signal-to-Noise Ratio (SNR).
Clause 15. The method of any of clauses 11-14, wherein the metadata includes one or more of a push flag and an urgent flag and wherein the method further comprises: transmitting, by the RLC layer, the one data transmission unit to a receiver device, in response to receiving the urgent flag from the application layer.
Clause 16. The method of clause 15, wherein data contained in the one data transmission unit corresponds to one application payload.
Clause 17. The method of any of clauses 11-16, further comprising: applying the ML model using the historical values of the model parameters to determine a total time required for transmission and acknowledgement of the one data transmission unit based on current communication channel conditions.
Clause 18. The method of clause 17, further comprising: comparing, by the RLC layer, the total time with a time remaining on a timer indicating a maximum allowable transmission time before potential synchronization loss.
Clause 19. The method of clause 18, further comprising: adjusting, by the RLC layer, a size of the one data transmission unit, in response to determining that the total time exceeds the time remaining on the timer.
Clause 20. Non-transitory computer-readable storage media having instructions encoded thereon, the instructions configured to cause processing circuitry to: send, by an application layer, metadata associated with one data transmission unit of a plurality of data transmission units, the metadata indicating that the one data transmission unit comprises a last data transmission unit associated with a particular application payload; receive, by a Radio Link Control (RLC) layer, the metadata associated with the one data transmission unit; apply a Machine Learning (ML) model, using historical values of model parameters of the ML model, to determine a likelihood of data loss; and set, by the RLC layer, a poll bit in the last data transmission unit when the likelihood of data loss exceeds a threshold.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes certain aspects and examples with reference to some illustrations, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

By way of example, various aspects of this disclosure may be implemented within systems defined by 3GPP, such as fifth-generation New Radio (5G NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP 2), such as CDMA 2000 and/or Evolution-Data Optimized (EV-DO). Other examples may be implemented within systems employing Institute of Electrical and Electronics Engineers (IEEE) 802.11 (Wi-Fi) standards, IEEE 802.16 (WiMAX) standards, IEEE 802.20, Ultra-Wideband (UWB) standards, Bluetooth standards, and/or other suitable standards. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-10 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-10 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A device for communication in a non-terrestrial communication system, comprising:
one or more memories configured to store:
historical values of model parameters of a machine learning (ML) model, and
one or more processors are configured to:
send, by an application layer, metadata associated with one data transmission unit of a plurality of data transmission units, the metadata indicating that the one data transmission unit comprises a last data transmission unit associated with a particular application payload;
receive, by a Radio Link Control (RLC) layer, the metadata associated with the one data transmission unit;
apply the ML model, using the historical values of the model parameters, to determine a likelihood of data loss; and
set, by the RLC layer, a poll bit in the last data transmission unit when the likelihood of data loss exceeds a threshold.

2. The device of claim 1, wherein the likelihood of data loss is indicated by an RLC Block Error Rate (BLER) and wherein the ML model is trained to predict the RLC BLER on an uplink (UL) channel.

3. The device of claim 2, wherein the one or more processors, to determine whether the likelihood of data loss exceeds the threshold, are configured to determine whether the RLC BLER exceeds the threshold.

4. The device of claim 1, wherein the historical values of the model parameters comprise historical values of one or more of: Hybrid Automatic Repeat reQuest-Round Trip Times (HARQ-RTT), HARQ BLER downlink (DL)/UL, RLC BLER DL/UL and Signal-to-Noise Ratio (SNR).

5. The device of claim 1, wherein the metadata includes one or more of a push flag and an urgent flag and wherein the one or more processors are further configured to:
transmit, by the RLC layer, the one data transmission unit to a receiver device, in response to receiving the urgent flag from the application layer.

6. The device of claim 5, wherein data contained in the one data transmission unit corresponds to one application payload.

7. The device of claim 1, wherein the one or more processors are further configured to:
apply the ML model using the historical values of the model parameters to determine a total time required for transmission and acknowledgement of the one data transmission unit based on current communication channel conditions.

8. The device of claim 7, the one or more processors are further configured to:
compare, by the RLC layer, the total time with a time remaining on a timer indicating a maximum allowable transmission time before potential synchronization loss.

9. The device of claim 8, the one or more processors are further configured to:
adjust, by the RLC layer, a size of the one data transmission unit, in response to determining that the total time exceeds the time remaining on the timer.

10. The device of claim 1, wherein the device comprises a base station or a User Equipment (UE).

11. A method for communication in a non-terrestrial communication system, comprising:
sending, by an application layer, metadata associated with one data transmission unit of a plurality of data transmission units, the metadata indicating that the one data transmission unit comprises a last data transmission unit associated with a particular application payload;
receiving, by a Radio Link Control (RLC) layer, the metadata associated with the one data transmission unit;
applying a Machine Learning (ML) model, using historical values of model parameters of the ML model, to determine a likelihood of data loss; and
setting, by the RLC layer, a poll bit in the last data transmission unit when the likelihood of data loss exceeds a threshold.

12. The method of claim 11, wherein the likelihood of data loss is indicated by an RLC Block Error Rate (BLER) and wherein the ML model is trained to predict the RLC BLER on an uplink (UL) channel.

13. The method of claim 12, wherein determining whether the likelihood of data loss exceeds the threshold comprises determining whether the RLC BLER exceeds the threshold.

14. The method of claim 11, wherein the historical values of the model parameters comprise historical values of one or more of: Hybrid Automatic Repeat reQuest-Round Trip Times (HARQ-RTT), HARQ BLER downlink (DL)/UL, RLC BLER DL/UL and Signal-to-Noise Ratio (SNR).

15. The method of claim 11, wherein the metadata includes one or more of a push flag and an urgent flag and wherein the method further comprises:
transmitting, by the RLC layer, the one data transmission unit to a receiver device, in response to receiving the urgent flag from the application layer.

16. The method of claim 15, wherein data contained in the one data transmission unit corresponds to one application payload.

17. The method of claim 11, further comprising:
applying the ML model using the historical values of the model parameters to determine a total time required for transmission and acknowledgement of the one data transmission unit based on current communication channel conditions.

18. The method of claim 17, further comprising:
comparing, by the RLC layer, the total time with a time remaining on a timer indicating a maximum allowable transmission time before potential synchronization loss.

19. The method of claim 18, further comprising:
adjusting, by the RLC layer, a size of the one data transmission unit, in response to determining that the total time exceeds the time remaining on the timer.

20. Non-transitory computer-readable storage media having instructions encoded thereon, the instructions configured to cause processing circuitry to:
send, by an application layer, metadata associated with one data transmission unit of a plurality of data transmission units, the metadata indicating that the one data transmission unit comprises a last data transmission unit associated with a particular application payload;
receive, by a Radio Link Control (RLC) layer, the metadata associated with the one data transmission unit;
apply a Machine Learning (ML) model, using historical values of model parameters of the ML model, to determine a likelihood of data loss; and
set, by the RLC layer, a poll bit in the last data transmission unit when the likelihood of data loss exceeds a threshold.
